(19) United States
(12) Patent Application Publication
(10) Pub. No.: US 2026/0252901 A1
(43) Pub. Date: Aug. 27, 2026

(54) SYSTEMS AND METHODS FOR FORESIGHT-BASED DATA GENERATION AND TRAINING GENERATIVE MODELS USING FORESIGHT LEARNING

(71) Applicant: Junto Tech, Inc., Jersey City, NJ (US)

(72) Inventor: Benjamin D. Turtel, New York, NY (US)

(73) Assignee: Junto Tech, Inc., Jersey City, NJ (US)

(21) Appl. No.: 19/548,633

(22) Filed: Feb. 24, 2026

Related U.S. Application Data
(60) Provisional application No. 63/762,473, filed on Feb. 24, 2025.

(51) Int. Cl. G06N 3/092

(52) U.S. Cl. CPC G06N 3/092

(57) ABSTRACT

A foresight-based data generation method may include (1) prompting a first model to generate tasks based on data available prior to a first time when outcomes of the events to which the tasks relate are unresolved; (2) obtaining the tasks generated by the first model, wherein the information state of the first model is cutoff prior to the first time; (3) prompting a second model to resolve the tasks based on data produced after the events resolve; (4) obtaining, from the second model, determinations regarding the outcomes of the events, wherein the information state of the second model is cutoff after the events resolve; and (5) producing task records, wherein each task record includes a task and a determination regarding the outcome of the event to which the task relates. The task records may be used to train, finetune, or evaluate predictive capabilities of generative models.

### CROSS-REFERENCE TO RELATED APPLICATION(S)

This application claims the benefit under 35 U.S.C. § 119 (e) of U.S. Provisional Application Ser. No. 63/762,473, titled “Systems and Methods for Training Generative Models Using Foresight Learning” and filed on Feb. 24, 2025, which is hereby incorporated by reference herein in its entirety.

### BACKGROUND

Reinforcement learning (RL) is a type of machine learning whereby an agent learns to make decisions by performing actions in an environment to increase (e.g., maximize) cumulative rewards. In some examples, the agent interacts with an environment (e.g., a physical or virtual environment) through a trial-and-error process, receiving feedback in the form of rewards or penalties, and adjusting its strategies (e.g., policies) to achieve a goal. Reinforcement learning can enable agents in various fields, including robotics, game playing, and autonomous systems, to learn complex behaviors and adapt to dynamic environments.

Reinforcement learning self-play (sometimes referred to herein simply as “self-play”) encompasses a reinforcement learning technique whereby an agent improves its performance by playing against one or more copies or past versions of itself. Self-play allows the agent to continuously challenge itself, promoting the development of more sophisticated strategies and behaviors. By engaging in self-play, the agent can explore a wide range of scenarios and learn from its own mistakes, leading to more robust and adaptive policies. This approach is particularly effective in environments where the agent's performance can be iteratively refined through repeated interactions.

Self-play has been successfully used to train agents for a variety of applications, including playing games that involve strategic decision-making. For example, the AlphaZero agent learned to play chess and Go at a high level by playing against itself. In general, self-play enhances the agent's ability to generalize and adapt to new situations, making it a powerful tool for developing advanced AI systems capable of autonomous learning and improvement.

### SUMMARY

In some aspects, the techniques described herein relate to a reinforcement learning method, including performing, by a processor, operations including: providing, as input to a first model, input data representing a task related to an outcome of an event, wherein the outcome of the event is unresolved at a first time; obtaining synthetic data provided by the first model based on the input data, the synthetic data indicating one or more predictions regarding the outcome of the event, wherein an information state observed by the first model is limited to data available prior to the first time; obtaining resolution data provided by a second model based on the input data, the resolution data indicating a determination regarding the outcome of the event, wherein the outcome of the event is resolved by a second time later than the first time, and wherein an information state observed by the second model includes data available after the second time; determining, based on the one or more predictions regarding the outcome and the determination regarding the outcome, one or more rewards corresponding, respectively, to the one or more predictions; and training the first model based on the one or more rewards.

In some aspects, the techniques described herein relate to a method, wherein the synthetic data are provided by the first model prior to the first time, and the resolution data are provided by the second model after the second time.

In some aspects, the techniques described herein relate to a method, wherein the resolution data are provided by the second model before the input data are provided as input to the first model, and wherein the information state observed by the first model is temporally masked.

In some aspects, the techniques described herein relate to a method, wherein the first model includes a predictive model.

In some aspects, the techniques described herein relate to a method, wherein each of the one or more predictions regarding the outcome of the event includes a binary label characterizing the outcome of the event, a multi-class label characterizing the outcome of the event, multi-label data characterizing the outcome of the event, or a number characterizing the outcome of the event.

In some aspects, the techniques described herein relate to a method, wherein the first model includes a generative model.

In some aspects, the techniques described herein relate to a method, wherein each of the one or more predictions regarding the outcome of the event includes a binary label characterizing the outcome of the event, a multi-class label characterizing the outcome of the event, multi-label data characterizing the outcome of the event, a number characterizing the outcome of the event.

In some aspects, the techniques described herein relate to a method, wherein each of the one or more predictions regarding the outcome of the event includes text data, image data, audio data, or video data characterizing the outcome of the event.

In some aspects, the techniques described herein relate to a method, wherein each of the one or more predictions regarding the outcome of the event includes a probability value indicating a probability of the event occurring.

In some aspects, the techniques described herein relate to a method, wherein the determination regarding the outcome of the event includes an occurrence value indicating whether the event occurred.

In some aspects, the techniques described herein relate to a method, wherein the occurrence value indicates that the event occurred, and for each prediction of the one or more predictions, the reward corresponding to the respective prediction is based on a logarithm of the probability value of the respective prediction.

In some aspects, the techniques described herein relate to a method, wherein the value indicates that the event did not occur, and for each prediction of the one or more predictions, the reward corresponding to the respective prediction is based on a logarithm of a complement of the probability value of the respective prediction.

In some aspects, the techniques described herein relate to a method, wherein each of the one or more predictions regarding the outcome of the event includes prediction data characterizing the outcome of the event and a probability value indicating a probability that the prediction data are correct.

In some aspects, the techniques described herein relate to a method, wherein the determination regarding the outcome of the event includes determination data characterizing the outcome of the event.

In some aspects, the techniques described herein relate to a method, wherein determining the one or more rewards corresponding to the one or more predictions includes, for each prediction and each corresponding reward: determining a correctness value indicating a correctness of the respective prediction based on the prediction data of the respective prediction and the determination data; determining a first reward term based on the correctness value and a logarithm of the probability value of the respective prediction; determining a second reward term based on a complement of the correctness value and a logarithm of a complement of the probability value of the respective prediction; and combining the first reward term and the second reward term.

In some aspects, the techniques described herein relate to a method, wherein determining the correctness value includes assessing a similarity of the prediction data of the respective prediction to the determination data.

In some aspects, the techniques described herein relate to a method, wherein training the first model based on the one or more rewards includes updating a policy of the first model based on a reinforcement learning algorithm and the one or more rewards.

In some aspects, the techniques described herein relate to a method, wherein the reinforcement learning algorithm is a group relative policy optimization (GRPO) algorithm, a modified GRPO algorithm, a ReMax algorithm, or a Direct Preference Optimization (DPO) algorithm.

In some aspects, the techniques described herein relate to a method, wherein the information state observed by the first model includes data used to train or fine-tune the first model and/or context data accessed by the first model.

In some aspects, the techniques described herein relate to a method, wherein each of the one or more rewards includes a value based on an accuracy of a prediction of the first model.

In some aspects, the techniques described herein relate to a reinforcement learning system, including: a processor; a computer-readable storage medium storing instructions which, when executed by the processor, cause the system to perform operations including: obtaining training data including input data and resolution data, wherein the input data represent a task related to an outcome of a real-world event, wherein the outcome is unresolved as of a first real-world time and resolved as of a second real-world time later than the first real-world time, wherein the resolution data are provided by a second model based on the input data, the resolution data indicating a determination regarding the outcome of the real-world event, and wherein an information state of the second model includes data available after the second real-world time; temporally masking an information state of a first model, such that the information state observed by the first model is limited to data available prior to the first time; providing the input data as input to the first model; obtaining synthetic data provided by the first model based on the input data, wherein the synthetic data indicate one or more predictions regarding the outcome of the real-world event, and wherein the information state observed by the first model is temporally masked; determining, based on the one or more predictions regarding the outcome and the determination regarding the outcome, one or more rewards corresponding, respectively, to the one or more predictions; and training the first model based on the one or more rewards.

In some aspects, the techniques described herein relate to a system, wherein obtaining the input data includes: extracting context data related to the real-world event from one or more first data records of a data source, wherein each of the one or more first data records includes a timestamp earlier than the first real-world time; prompting a generative model to generate the task regarding the outcome of the real-world event based on the extracted context data; and obtaining, from the generative model, the task.

In some aspects, the techniques described herein relate to a system, wherein the information state of the second model includes one or more second data records of the data source, wherein each of the one or more second data records includes a timestamp later than the first real-world time and/or later than the second real-world time.

In some aspects, the techniques described herein relate to a method including performing, by a processor, operations including: generating, using a first model, response data indicating a prediction regarding an outcome of a second event, wherein the response data are generated based on task data provided as input to the first model, wherein the task data represent a task related to the outcome of the second event, wherein the response data are generated at a third time and the outcome of the second event is unresolved at the third time; wherein the first model has been trained, using a reinforcement learning algorithm, training data, and one or more rewards, to generate predictions regarding outcomes of events, wherein the training data include input data and resolution data, wherein the input data represent a task regarding an outcome of a first event, wherein the outcome of the first event is unresolved as of a first time and resolved as of a second time later than the first time, wherein synthetic data are provided by the first model based on the input data and an information state observed by the first model, wherein the synthetic data indicate one or more predictions regarding the outcome of the first event, wherein the information state observed by the first model is limited to data available prior to the first time, wherein the resolution data are provided by a second model based on the input data and an information state observed by the second model, wherein the resolution data indicate a determination regarding the outcome of the first event, and wherein the information state observed by the second model includes data available after the second time, wherein the one or more rewards are determined based on the one or more predictions and the determination.

In some aspects, the techniques described herein relate to a method including: providing, to a first generative model, a first prompt to generate one or more tasks based on first data available prior to a first time, wherein the one or more tasks relate to one or more outcomes of one or more events, and wherein the one or more outcomes of the one or more events are unresolved at the first time; obtaining the one or more tasks generated by the first generative model based on the first data, wherein an information state of the first generative model is limited to data available prior to the first time when the first generative model generates the one or more tasks; providing, to a second generative model, a second prompt to resolve the one or more tasks based on second data produced after a second time subsequent to the first time; obtaining resolution data generated by the second generative model based on the second data, wherein the resolution data indicate one or more determinations regarding the one or more outcomes of the one or more events to which the one or more tasks relate, wherein an information state of the second generative model includes data available after the second time when the second generative model generates the resolution data; and producing, based on the one or more tasks and the resolution data, a data set including one or more task records, wherein each task record of the one or more task records includes a respective task of the one or more tasks and a respective determination of the one or more determinations, the respective determination regarding the outcome of the event to which the respective task relates, wherein each task record of the one or more task records further indicates the first time and the second time.

In some aspects, the techniques described herein relate to a method, wherein the first generative model is the second generative model.

In some aspects, the techniques described herein relate to a method, further including temporally masking the information state of the first generative model, such that the information state of the first generative model is limited to data available prior to the first time when the first generative model generates the one or more tasks.

In some aspects, the techniques described herein relate to a method, wherein the first data include one or more first timestamped data records, the second data include one or more second timestamped data records, the one or more first timestamped data records and the one or more second timestamped data records are stored in a data store, and temporally masking the information state of the first generative model includes configuring the data store to prevent the first generative model from accessing timestamped data records having timestamps after the first time.

In some aspects, the techniques described herein relate to a method, wherein the first data include one or more first chronologically ordered data records, the second data include one or more second chronologically ordered data records, the one or more first chronologically ordered data records and the one or more second chronological ordered data records are stored in a data store, and temporally masking the information state of the first generative model includes configuring the data store to prevent the first generative model from accessing data records subsequent in chronological order to the one or more first chronologically ordered data records.

In some aspects, the techniques described herein relate to a method, wherein producing the data set includes, for each task of the one or more tasks: determining whether the respective task satisfies one or more quality criteria; if the respective task satisfies the one or more quality criteria, adding a record corresponding to the respective task to the data set; and otherwise, excluding the record corresponding to the respective task from the data set.

In some aspects, the techniques described herein relate to a method, wherein the one or more quality criteria include a difficulty criterion, and wherein the difficulty criterion is satisfied when a difficulty of correctly predicting, at the first time, the outcome of the event to which the respective task relates exceeds a prediction difficulty threshold.

In some aspects, the techniques described herein relate to a method, wherein the one or more quality criteria include a verifiability criterion, and wherein the verifiability criterion is satisfied when a difficulty of verifying, after the second time, the outcome of the event to which the respective task relates is less than a verification difficulty threshold.

In some aspects, the techniques described herein relate to a method, further including: receiving user input identifying a domain for the one or more tasks; retrieving, from a data source storing a plurality of data records, one or more first data records relating to the identified domain, wherein the data source indicates that the one or more first data records were available prior to the first time; and retrieving, from the data source, one or more second data records relating to the identified domain, wherein the data source indicates that the one or more second data records were produced after the second time, wherein the first data include the one or more first data records and the second data include the one or more second data records.

In some aspects, the techniques described herein relate to a method, further including training or fine-tuning a third model to predict outcomes of events based on the data set.

In some aspects, the techniques described herein relate to a method, further including testing an ability of a third model to predict outcomes of events based on the data set.

In some aspects, the techniques described herein relate to a method, wherein the task is a predictive task.

In some aspects, the techniques described herein relate to a method, wherein the task includes predicting an outcome of an event or generating content related to a predicted outcome of an event.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a system for foresight-based data generation and/or for training a generative model using foresight learning, according to some embodiments; and

FIG. 2 is a flowchart of a foresight-based data generation method, according to some embodiments;

FIG. 3 is a flowchart of a foresight-based reinforcement learning (RL) method, according to some embodiments;

FIG. 4 is a flowchart of another foresight-based reinforcement learning (RL) method, according to some embodiments;

FIG. 5 is a flowchart of a predictive method, according to some embodiments;

FIG. 6 is a flowchart of an example of an online, foresight-based data generation process;

FIG. 7 is a diagram illustrating the temporal structure of an online, foresight-based data generation process, according to some embodiments;

FIG. 8 is a diagram illustrating the temporal structure of an offline, foresight-based data generation process, according to some embodiments;

FIG. 9 is a block diagram of a system for foresight learning with self-play, according to some embodiments;

FIG. 10 is a bar chart showing an example of expected calibration error (ECE) of a set of models;

FIG. 11 is a line graph illustrating example calibration values for the four models of FIG. 10 across a range of predicted probabilities;

FIG. 12 shows example trend lines fitted to the calibration values of FIG. 11;

FIG. 13 shows an example of a prompt for extracting event statements;

FIG. 14 shows an example of a prompt for mutating True event statements into False event statements;

FIG. 15 shows an example of a prompt for filtering event statements;

FIG. 16 shows an example of a prompt for transforming past-tense event statements into prediction tasks;

FIG. 17 shows an example of a prompt for performing a quality assurance check on task/outcome pairs;

FIG. 18 shows example calibration results for a set of experimental models and benchmark models;

FIG. 19 shows a line graph of example cumulative realized profit for a set of models and bar graphs of example aggregated profits of the models in various scenarios;

FIG. 20 shows for an example model trained with foresight learning, model calibration and accuracy metrics versus training steps on a Metaculus evaluation dataset (top) and a synthetic future-events evaluation dataset (bottom); and

FIG. 21 is a block diagram of a computing device, according to some embodiments.

### DETAILED DESCRIPTION

### Overview of Foresight-Based Data Generation and Foresight Learning

The present disclosure describes systems and methods for foresight-based data generation. As described in further detail below, foresight-based data generation techniques can transform real-world reasoning into a verifiable task, without human labeling or curation of data. Thus, foresight-based data generation techniques can produce task data (e.g., data describing predictive tasks relating to the unresolved outcomes of events) and resolution data (e.g., data describing the resolved outcomes of the events) at a practically unlimited scale. Such data can be used for model training or testing (e.g., benchmarking). In some embodiments, foresight-based data generation techniques turn any suitable stream of data, including the entire internet, into training data, since the system can ask questions about the future state of any stream of data.

The present disclosure also describes systems and methods for training generative models (e.g., LLMs) using “foresight learning,” a novel technique that enables generative models to learn real-world reasoning based on training data generated using foresight-based data generation techniques. In some examples, foresight learning techniques can be used to scale the training and domain applicability of generative models.

In some examples, through self-play, an AI model can interact with itself to generate training data and train (e.g., fine-tune) itself using the generated training data, thereby enhancing the model's capabilities. Self-play can create a virtuous cycle of learning: as the model generates more training data and trains on that data, the model improves; as the model improves, the model generates more and better training data (e.g., training data derived from more sophisticated reasoning strategies); and so on. The self-play paradigm is suitable not only for an LLM learning to play a game by playing against itself, but for any generative model learning to carry out any type of verifiable task by completing (or attempting to complete) an instance of the task and then comparing the content generated by the model for that instance of the task to verified content representing correct completion of the task. Self-play is generally applicable to scenarios in which the task performed by a generative model is verifiable (e.g., the correctness or suitability of the content generated by the model is verifiable).

However, the self-play paradigm has not been successfully used to train generative models to carry out real-world reasoning (e.g., to learn reasoning strategies similar to or superior to the reasoning strategies used by humans). The inventors have recognized and appreciated that one reason for this failure has been the absence of techniques for automatically (1) generating verifiable, real-world reasoning tasks at scale, (2) prompting models to complete these tasks, (3) evaluating the suitability (e.g., accuracy) of the models' generated content at scale, and (4) training or fine-tuning the models to favor the reasoning techniques that yield more suitable results. This disclosure describes such techniques (referred to herein as “foresight learning” techniques), which enable generative models to learn real-world reasoning through automated self-play.

In some examples, foresight learning techniques can continuously improve the forecasting and reasoning capabilities of generative models using a cycle of task generation (e.g., question generation), task completion (e.g., reasoning and prediction), and outcome evaluation (e.g., resolution and training) based on real-world events. In some examples, foresight learning allows a model to explore new reasoning strategies that improve (e.g., optimize) the model's ability to predict real-world outcomes, potentially surpassing human-level forecasting abilities.

Foresight-based data generation and foresight learning techniques can provide a new paradigm for developing models with robust reasoning skills (e.g., general super-intelligence). In some examples, models trained using foresight learning (1) can exhibit unprecedented predictive capabilities for strategic planning, threat assessment, and decision-making in complex geopolitical scenarios; (2) can generate hypotheses and experiments to advance knowledge and discovery across various scientific fields; (3) can exhibit significant improvements in market prediction, risk assessment, and long-term strategic planning in business and finance scenarios; (4) can provide enhanced disease risk prediction, disease diagnosis, treatment planning, and drug discovery capabilities in healthcare scenarios; and (5) can provide improved climate modeling and climate mitigation strategy planning.

Foresight learning is not limited by human reasoning capabilities. The questions produced using foresight-based data generation processes can include many questions that humans are unable to answer ahead of time. Training on such questions encourages generative models to explore and learn new potential ways of modeling the world without humans knowing how to teach them.

Foresight learning relies on questions about the future, which are, by their nature, always out of sample. Training on out of sample questions forces models to reason their way to predictions, rather than memorizing answers or leveraging accidental exposure to resolutions.

### Generative Artificial Intelligence (AI)

Generative artificial intelligence (AI) agents have the ability to generate new and original content, including text, imagery, audio, source code, synthetic data, etc. Generative AI agents, driven by AI algorithms and advanced neural networks, empower machines to go beyond traditional rule-based programming and engage in autonomous, creative decision-making. By leveraging vast amounts of data and the power of machine learning, generative AI agents can generate new content, simulate human-like behavior, and even compose music, write code, and create visual art. This technology is quickly impacting diverse industries and sectors, from healthcare and finance to manufacturing and entertainment.

Generative AI agents can include generative models capable of analyzing existing content, identifying patterns in the content, and combining or modifying the identified patterns to generate new content. The new content can include text, images, video, music, or any other suitable type of content. Some non-limiting examples of generative models include generative adversarial networks (GANs), variational autoencoders (VAEs), autoregressive models (e.g., large language models (LLMs)), recurrent neural networks (RNNs), transformer-based models, reinforcement learning models for generative tasks, diffusion models (e.g., stable diffusion models), etc. Many generative models include artificial neural networks (ANNs) trained using Deep Learning (DL) techniques. Deep Learning involves the use of complex algorithms to train ANNs to recognize patterns and make predictions based on large amounts of data. Deep Learning algorithms can learn multiple layers of representations, allowing them to model highly nonlinear relationships in the data. This ability makes them particularly effective for applications such as image and speech recognition, natural language processing (NPL), etc.

In many Generative AI systems, the generative model that generates content is a large language model (LLM). A large language model (LLM) is a type of ML model that can perform a variety of natural language processing (NLP) tasks such as generating and classifying text, answering questions in a conversational manner, and translating text from one language to another. The term ‘large’ refers to the number of values (parameters) the language model can change autonomously as it learns. Some LLMs have hundreds of billions of parameters. In general, LLMs are neural network models that have been trained using deep learning techniques to recognize, summarize, translate, predict, and generate content using very large datasets.

Many state-of-the-art LLMs and other generative models use a class of deep learning architectures called transformer neural networks (“transformer networks” or “transformers”). Transformers can learn context and meaning by tracking relationships between data units, such as the words in a sentence. A transformer can include multiple transformer blocks, also known as layers. For example, a transformer may have self-attention layers, feed-forward layers, and normalization layers, all working together to decipher input to predict (or generate) streams of relevant output. The layers can be stacked to make deeper transformers and powerful language models. Transformer-based models generally have an encoder-decoder architecture, use an attention mechanism (e.g., scaled dot-product attention, multi-head attention, masked attention, etc.) to model the relationships between different elements in a sequence of content, and perform well when processing long sequences of content. Some non-limiting examples of transformer-based models include Generalized Pre-trained Transformer 4 (GPT-4), DALL-E3, etc. Other examples of generative models with text-processing capability include Jurassic-1, Command, and Paradigm.

“Completion” may refer to the process of a generative model generating additional content based on a provided prompt, e.g., providing the next word in a sentence. In some examples, the additional content provided by the generative model may be referred to as a “completion.” Completions generated by generative models may include text, audio data (e.g., speech, music, etc.), image data (e.g., images), video data (e.g., videos), time-series data, or any other suitable type of data. “Prompting” may refer to a technique in which a generative model is matched to a desired downstream task by formulating the task as natural language text explaining the desired behavior, such that a generative model can carry out the task by performing text completion. “Fine-tuning” may refer to the process whereby a generative model is adapted to a particular task by changing its parameters by providing prompts with examples of preferred and/or non-preferred completions.

### Systems and Methods for Foresight Learning

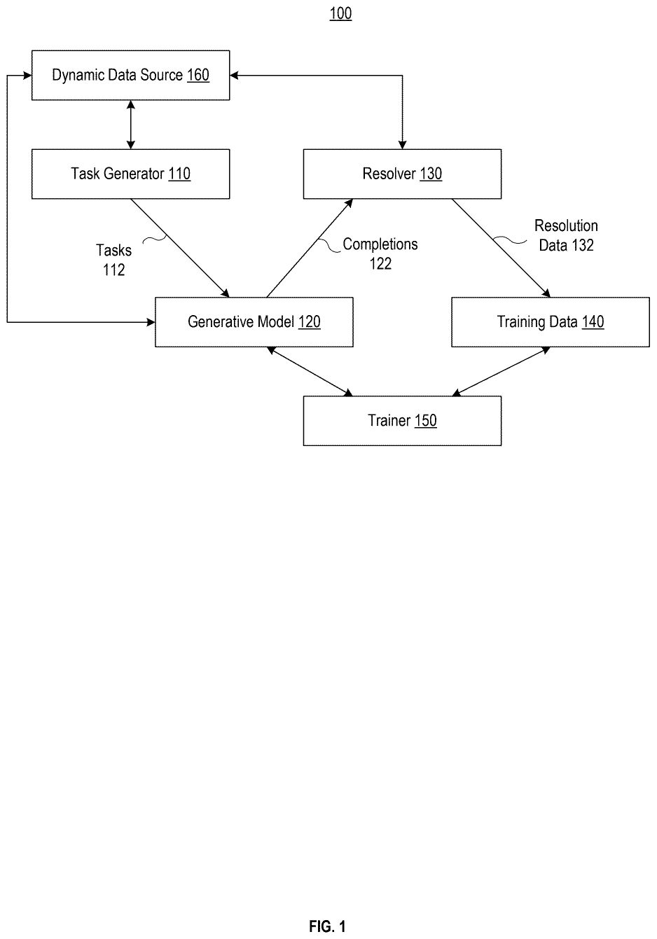

FIG. 1 shows an example of a foresight learning system 100 (e.g., a system for training a generative model using foresight learning). In some embodiments, the foresight learning system 100 includes a task generator 110, a generative model 120, a resolver 130, training data 140, and a trainer 150. In some embodiments, the foresight learning system 100 includes or is communicatively coupled to a dynamic data source 160. Some embodiments of the foresight learning system's components are described in further detail below.

The dynamic data source 160 may include any suitable data source that is updated from time-to-time (e.g., intermittently, periodically, in real-time, etc.). In some examples, the dynamic data source 160 includes the Internet and any or all data accessible via the Internet. The dynamic data source 160 may provide data related to any suitable topic or domain (e.g., news data, video and/or image data, financial data, environmental data, sports and/or entertainment data, social media and/or Internet analytics data, economic data, prediction market data, etc.).

News data can include, without limitation, real-time news feeds, newspaper articles, press releases, official statements, any other data describing, relating to, or derived from news or news events, etc. Some non-limiting examples of data sources for news data can include GDelt, Exa.ai, NewsAPI, Reuters API, Bloomberg Terminal, Associated Press API, LexisNexis API, Twitter/X API (e.g., for breaking news), etc.

Video and/or image data can include, without limitation, video and/or images provided by security cameras, traffic cameras, satellites, or drones; video of event broadcasts; any other data describing, relating to, depicting, or derived from video or images; etc. Some non-limiting examples of data sources for video and/or image data can include APIs provided by transportation departments of various government entities, EarthEngine API for satellite data, YouTube Live Streaming API, Twitch API, security camera system APIs (e.g., Axis, Hikvision), etc.

Financial data can include, without limitation, prices, values, or transaction volumes for stocks, cryptocurrencies, commodities, or any suitable financial instruments; foreign exchange rates; any other data describing, relating to, or derived from financial markets, exchanges, instruments, or events; etc. Some non-limiting examples of data sources for financial data can include Alpha Vantage API, Yahoo Finance API, Coinbase API, Binance API, Bloomberg API, CoinGecko API, etc.

Environmental data can include, without limitation, data provided by weather sensors, climate monitors, pollution meters, seismic sensors, or other sensors; any other data describing, relating to, or derived from environments, environmental events, and/or weather conditions, patterns, or events; etc. Some non-limiting examples of data sources for environmental data can include National Oceanic and Atmospheric Administration (NOAA) API, Open WeatherMap API, Environmental Protection Agency (EPA) Air Quality API, U.S. Geological Survey (USGS) Earthquake API, National Aeronautics and Space Administration (NASA) Earth Data API, etc.

Sports and/or entertainment data can include, without limitation, live game statistics, wagering odds, viewership statistics, social media engagement statistics, any other data describing, relating to, or derived from sports, entertainment, or sports/entertainment events, etc. Some non-limiting examples of data sources for environmental data can include Entertainment and Sports Programming Network (ESPN) API, Sports Radar API, Spotify API, Netflix Viewing Stats API, TheMovieDB API, etc.

Social media and/or Internet analytics data can include, without limitation, social media posts, trending topics statistics, website traffic statistics, search trend statistics, any other data describing, relating to, or derived from social media and/or Internet activity or events, etc. Some non-limiting examples of data sources for social media and/or Internet analytics data can include Twitter/X API, Meta API, Google Trends API, Similarweb API, TikTok API, Reddit API, etc.

Economic data can include, without limitation, gross domestic product (GDP) data, employment data, inflation rate data, consumer spending data, any other data describing, relating to, or derived from economic conditions or events, etc. Some non-limiting examples of data sources for economic data can include Federal Reserve Economic Data (FRED) API, World Bank API, Bureau of Labor and Statistics (BLS) API, Eurostat API, International Monetary Fund (IMF) Data API, etc.

Prediction market data can include, without limitation existing prediction market questions and odds, any other data describing, relating to, or derived from prediction markets or prediction market events, etc. Some non-limiting examples of data sources for prediction market data can include Polymarket API, Manifold Markets API, Metaculus API, PredictIt historical data, etc.

The task generator 110 may be configured to generate verifiable, time-bound reasoning tasks 112 (or task data including one or more tasks 112). In some examples, the suitability (e.g., correctness) of a model's completion of a reasoning task 112 is not verifiable at a first date/time (e.g., the model's cutoff date, the date/time when the task is generated, etc.), but is or may be verifiable at a second date/time (e.g., a date/time subsequent to the model's cutoff date, a date/time after the task is generated, etc.). As just one example, generating a verifiable, time-bound reasoning task may involve generating a question about a future, not-yet-resolved real-world event. Many non-limiting examples of such questions are described below, along with non-limiting examples of preferred attributes of such questions and non-limiting examples of techniques for generating such questions. In some examples, generating a verifiable, time-bound reasoning task involves generating a task about content to be generated in the future (e.g., “Design the dress that Taylor Swift will wear to the Grammy Awards ceremony in 2027,” “Draw the first work of art publicly attributed to Banksy after Dec. 31, 2026,” “Describe the results of the soon-to-be conducted clinical trial of a particular therapeutic's efficacy for treating a particular condition,” etc.).

Some non-limiting examples of verifiable, time-bound reasoning tasks in the news domain may include the following queries: 1. What is the probability of a Ukraine-Russia peace treaty by Jul. 1, 2026? 2. Who will win the 2028 U.S. Presidential Election? 3. Will China's GDP growth exceed 5% in 2026? What is the probability of successful EU-UK trade negotiations by December 2026?

Some non-limiting examples of verifiable, time-bound reasoning tasks relating to video and image data may include the following queries: 1. What is the probability of traffic congestion lasting >2 hours on Highway I-95 tomorrow? 2. Will the crowd size at Times Square exceed 100,000 people on New Year's Eve in 2026? 3. What is the likelihood of severe flooding in Venice's St. Mark's Square in the winter of 2027?

Some non-limiting examples of verifiable, time-bound reasoning tasks in the finance domain may include the following queries: 1. Will Google stock trade between $210-$230 on Mar. 1, 2026? 2. Will Bitcoin trade at $100,000 on Dec. 31, 2026? 3. What is the probability of gold prices surpassing $2,500/oz in Q2 2026?

Some non-limiting examples of verifiable, time-bound reasoning tasks in the environmental domain may include the following queries: 1. What is the probability of Category 4+ hurricane hitting Florida in 2026? 2. Will global average temperatures exceed 2024 levels by >0.5° C. by 2100? 3. What are the chances of AQI exceeding 150 in Beijing next week?

Some non-limiting examples of verifiable, time-bound reasoning tasks in the sports and entertainment domain may include the following queries: 1. Will the Kansas City Chiefs win Super Bowl LXI? 2. What is the probability of breaking the NBA single-game scoring record in 2027? 3. Will Taylor Swift's next album achieve >2 million first-week sales?

Some non-limiting examples of verifiable, time-bound reasoning tasks in the social media and Internet analytics domain may include the following queries: 1. Will Elon Musk have over 300 M followers by the end of 2027? 2. What topics will be trending on Monday next week? 3. Will any AI-generated content creator surpass 50 M followers in 2026?

Some non-limiting examples of verifiable, time-bound reasoning tasks in the economics domain may include the following queries: 1. Will the U.S. inflation rate fall below 2% by December 2026? 2. What is the probability of a technical recession in the EU in 2026? 3. Will global semiconductor sales exceed $600B in 2026?

Some non-limiting examples of verifiable, time-bound reasoning tasks in the prediction market domain may include the following queries: 1. Who will win the next U.S. Presidential election? 2. Will the Las Vegas Raiders finish 2026 with the worst record in the NFL?

In some examples, the task generator 110 is specifically configured to generate tasks (e.g., prompts or questions) regarding future, not-yet-resolved, real-world events. In some examples, the task generator 110 generates tasks 112 based on information retrieved from a data source (e.g., the dynamic data source 160).

In some examples, the task generator generates individual portions (e.g., fields) of a task and combines those portions into a task using a template (e.g., a prompt template). The task portions can be generated jointly (e.g., in a single step performed by the task generator) or separately (e.g., in multiple steps performed by the task generator). In some examples, individual portions of the task can include a task kernel, an expected resolution date, one or more resolution criteria, and/or context information from which the task kernel was derived. In some examples, the task kernel describes the task to be performed by the model (e.g., a question to be answered, a prediction to be provided, an event to which the question or prediction relates, etc.). In some examples, the expected resolution date indicates the date and/or time when the event that is the subject of the task kernel is expected to be resolved (e.g., the outcome of the event is expected to be verifiable). In some examples, the resolution criteria indicate how the outcome of the event can be verified. In some examples, the context information identifies (e.g., summarizes) information obtained from the dynamic data source 160 that served as a basis for generating the task kernel.

The task generator 110 can be implemented using any suitable techniques, including but not limited to automatic question generation (AQG) techniques as described in Mulla et al., “Automatic question generation: a review of methodologies, datasets, evaluation metrics, and applications,” Prog Artif Intell. 2023 Jan. 30; 12 (1): 1-32. In some examples, the task generator includes a context extraction facility and a generative model (e.g., an LLM). The context extraction facility may extract context information related to an event from the dynamic data source 160. Any suitable techniques for extracting context information related to an event can be used. The task generator can then present the extracted context information to its generative model and prompt the model to generate tasks (e.g., questions) about events that are the subject of or otherwise related to the context information.

In some embodiments, the task generator 110 is configured to generate tasks 112 that prompt the generative model to answer questions or generate predictions (or related predictive content) regarding event outcomes that are measurable (e.g., concrete), time-limited (e.g., time-bound), resolvable (e.g., verifiable), and/or non-obvious (e.g., unpredictable; not easily resolved using sub-human reasoning). Some non-limiting examples of techniques for generating tasks having such attributes are described in example 3. In some examples, generated tasks 112 can specifically identify dates on which or by which the event outcome will be resolved. Structuring the tasks 112 in this way can make it significantly easier for the resolver 130 to evaluate the suitability of the generative model's completions 122.

In some examples, the task generator 110 creates diverse, high-quality questions at scale for the system to reason about and predict outcomes for. The task generator can create questions based on data obtained from any suitable data stream (e.g., live data stream). In some examples, the task generator creates such questions by using a generative model to generate questions from the current context of a stream of data regarding what information that may be revealed in that stream of data in the future. For example, if the task generator is shown an article about an election before the outcome of the election, it may generate the question “Who will win the election?” or “By what margin will candidate A win the election?” In this sense, the task generator can be topic agnostic-any data stream that can be provided to an AI model (as text, video, image, audio, etc.) can be fodder for task generation (and later, resolution).

In some examples, the task generator can generate novel tasks inspired by current context data. In some examples, the task generator can generalize across any data feed(s) from which data can be obtained and provided as input to an AI model. In some examples, the task generator is domain-agnostic and capable of generating tasks related to a wide range of topics and across a variety of complexity levels, since tasks can be generated based on any suitable data stream. In some examples, the task generator produces tasks with clear resolution criteria and time frames.

The generative model 120 (sometimes referred to herein as a “reasoner” or “predictor”) may include one or more models of any suitable type. Some examples of generative models are described herein. In some embodiments, the generative model 120 generates completions 122 in response to tasks 112. In some embodiments, the completions 122 include answers to questions about events that are the subject of the tasks 112 and/or predictions about events that are the subject of the tasks 112 (e.g., predicted outcomes, predicted content, probabilities of events occurring, etc.). In some embodiments, the completions 122 further include representations of the reasoning used by the generative model 120 to produce the predictions. In some examples, a completion 122 includes a confidence score indicating the generative model's confidence in the accuracy of the completion's answer/prediction. In some examples, the generative model 120 can generate multiple, distinct completions in response to a prompt to complete a task 112 (e.g., using multiple, distinct reasoning processes or strategies such as chain of thought (CoT) reasoning, Internet of Things (IoT) reasoning, etc.).

In some examples, a completion 122 includes a predicted probability of occurrence of an event (e.g., an event identified in a task 112). In some examples, a completion 122 can include any form of content that can be measured against the “correct” content. Examples may include producing a text answer and measuring divergence of the produced text answer from the “correct” text answer, or producing code that produces an answer and measuring that answer against the “correct” answer, or producing a numerical answer and measuring that numerical answer against the “correct numerical answer, etc. (In this context, the “correct” answer may be an answer provided by the resolver 130, such as an answer provided with high confidence). In some examples, the generated answers can be ranked according to their divergence from a correct answer.

The resolver 130 may be configured to resolve the tasks 112 (e.g., to determine the outcomes of the events to which the tasks pertain). In some embodiments, the task generator 110 uses first context information available on or before a first date/time to generate tasks 112 relating to events that have not resolved as of the first date/time but may resolve on or before a second date/time subsequent to the first date/time. In some examples, the first context information includes information produced (e.g., first made available by the dynamic data source 160) after the cutoff date of the task generator's model and on or before the first date/time. In some examples, the first context information excludes information produced before the cutoff date of the task generator's model and/or information produced after the first date/time. In some embodiments, the resolver 130 uses second context information available on or before the second date/time to resolve the tasks 112. For example, the resolver 130 can resolve tasks 112 based on second context information produced between the first date/time and the second date/time.

The resolver 130 can resolve the tasks 112 using any suitable tools and/or techniques. In some embodiments, the resolver 130 queries the dynamic data source 160 to determine whether the events to which the tasks 112 relate have resolved and, if so, to determine the outcomes of those events. In some embodiments, the resolver 130 queries or prompts one or more tools (e.g., cloud-based software services) to describe the outcome of an event that is the subject of a task 112, and resolves the task based on the descriptions provided by those tools. For example, the resolver 130 may select the outcome provided by a majority of the tools. In some examples, if the queried tools do not agree on the outcome of the event, the resolver may label the task as unresolvable or resolved with low confidence. In some examples, the tools include the generative model 120. That is, the same model that completes a task 112 (e.g., using first context information) can subsequently resolve the task 112 or contribute to the task's resolution (e.g., using second context information). In some examples, the tools include one or more models other than (or in addition to) the generative model 120. In some examples, the tools do not include any generative models. Some other non-limiting examples of suitable tools may include Gemini, Exa, Perplexity, ChatGPT, etc.

In some examples, the resolver 130 considers the completions 122 generated by the generative model 120 for a task 112 and selects one of those completions 122 as the most suitable resolution of the task 112. For example, the resolver 130 can include a generative model that is prompted to resolve a task 112 by selecting one of the completions 122 as the most suitable resolution.

In some embodiments, resolving a task 112 includes providing a label and/or other content indicating an outcome of the task. For example, if a task 112 elicits a binary prediction (yes/no) about whether an event will occur, and the resolver determines that the event did occur, the resolver 130 can provide a label indicating that the event occurred (e.g., label=“yes,” etc.). As another example, if a task 112 elicits a probabilistic prediction (e.g., a probability value between 0 and 1) about whether an event will occur, and the resolver determines that the event did occur, the resolver can provide a label indicating that the event occurred (e.g., label=1), and the trainer 150 can select the completion 122 that predicted the event's occurrence with the highest probability as the most suitable completion for that task. In another example, if a task 112 elicits an answer to a question (e.g., content indicating an answer to a question), and the resolver 130 determines the actual answer to the question (e.g., “Blue”), the resolver can provide content indicating the answer to the question (e.g., the text string “Blue”), and the trainer can select completion(s) 122 that correctly predicted the answer to the question as positive examples.

In some examples, the resolver 130 does not resolve the tasks 112 with 100% accuracy. The foresight learning system 100 may significantly improve the reasoning skills of the generative model 120 through self-play or other training techniques as long as the accuracy with which the resolver 130 determines the outcomes of events to which the tasks relate (e.g., using context information available after the events' real-world resolution) exceeds the accuracy with which the generative model 120 predicts those outcomes (e.g., using only context information available prior to the events' real-world resolution). Thus, the efficacy of the foresight learning system 100 is not dependent on an omniscient resolver.

By evaluating the accuracy of completions (e.g., predictions) once real-world outcomes are resolved, the resolver 130 can provide crucial feedback for model improvement. If completions (e.g., reasonings and predictions) are produced ahead of the resolution (as described in the Direct Preference Optimization (DPO) example below), the resolver 130 can include a generative model (e.g., an LLM) with access to a dynamic data source (e.g., the internet), which can search and check the answer to a question after the fact. For example, if a question before an election was “Who will win the election?,” at the end of the election the resolver 130 can use an API (e.g., the Perplexity API) to ask “who won the election?” Even if the resolver 130 is not 100% accurate, overall the accuracy difference between what is known at reasoning and what is known after the fact is information that can be used to train the model 120.

Alternatively, the system 100 can start with the resolution data 132. In this case, the resolver 130 can take an article from after the election, generate the question and answer pair (as described in the Group Relative Policy Optimization (GRPO) example below), and train a model with a cutoff date in the past, prior to the date when the election's outcome was resolved. This scenario is simpler, as the task generator 110 and the resolver 130 can be a single component that simultaneously generates both tasks 112 and their resolution data 132 based on the same content.

In some examples, the resolver 130 evaluates the suitability (e.g., correctness) of the completions 122 produced by the generative model 120 based on the determined outcomes of real-world events, and determines rewards or penalties for training algorithms based on the suitability of the completions. In some examples, the resolver 130 ranks reasoning processes applied by the generative model 120 based on the suitability of the completions 122 produced using those reasoning processes.

In some examples, the system 100 incorporates a time delay between generation of tasks 112 and generation of resolution data 132, to allow time for real-world outcomes to unfold. In some examples, the resolver 130 uses web searches to gather information about outcomes. In some examples, the resolver 130 includes a generative model (e.g., LLM) that resolves the outcomes of the events to which the tasks 112 pertain. In some examples, that generative model is a commercially available LLM. Optionally, the resolver's generative model may be fine-tuned to resolve the outcomes of real-world events.

In some examples, the ability to assess the trustworthiness of various data sources is an emergent capability of generative models 120 trained by the foresight learning system 100, because the models learn to ignore or place low weight on information provided by data sources that do not add predictive value. Thus, in some examples, the resolver 130 may query one or more models previously trained by the foresight learning system 100 to resolve new tasks 112.

A major problem for search engines and answer engines on the internet today is that much of the information is incorrect, intentionally misleading, and often generated specifically to game the results consumers see in search engine optimization (SEO)/answer engine optimization (AEO). The untrustworthiness of information on the internet presents a problem that can be difficult to account for in model training (e.g., in a reward function). By optimizing models based on the accuracy of their predictions, however, foresight learning bakes assessments of information trustworthiness into the models; foresight learning naturally incentivizes the models to learn which sources are reliable since unreliable sources lead to inaccurate predictions. The “truest” information is that which helps a model accurately predict the future, so the model naturally learns how to determine to what extent a source can be trusted. This emergent capability is described in further detail in Example 1.

In some embodiments, the trainer 150 is a functional facility configured to train (e.g., fine-tune) the generative model 120 using the training data 140 and any suitable training process (e.g., reinforcement learning, DPO, GRPO, etc.). In some examples, the trainer 150 includes or provides a reward model. The reward model may be configured to assess (e.g., score, rank, etc.) the suitability of completions 122 generated by the generative model 120 for tasks 112 based, at least in part, on the resolved outcomes of those tasks as provided by the resolver 130. In some embodiments, the reward model may determine which of the completions 122 generated in response to a task 112 are suitable and which are unsuitable, based on a comparison of the completions 122 and the resolved outcomes of the events. In some embodiments, the reward model may assign scores to the completions 122 generated in response to a task 112 indicating the relative suitability of the completions, based on a comparison of the completions 122 and the resolved outcomes of the events. In some embodiments, the reward model may rank the completions 122 generated in response to a task 112 according to their suitability, based on a comparison of the completions 122 and the resolved outcomes of the events.

In some embodiments, the trainer 150 provides training data 140, which may include task data (e.g., the tasks 112 generated by the task generator 110), completion data (e.g., the completions 122 generated by the generative model 120 in response to being prompted to complete the tasks 112), and/or the resolution data 132 generated by the resolver 130 for the tasks 112 (e.g., data indicating resolved outcomes of the events to which the tasks 112 relate). In some examples, the completions 122 include explanations (e.g., summaries) of the reasoning strategies used by the generative model 120 to produce the completions. In some examples, the resolution data for a task 112 includes a label indicating the task's outcome and/or content (e.g., a text statement) describing the task's outcome. In some embodiments, the trainer 150 uses the training data 140 and the reward model's assessment (e.g., scores, rankings, etc.) of the completions in the training data to train (e.g., fine-tune) the generative model 120 from time-to-time (e.g., periodically, intermittently, in response to user input, etc.). Any suitable training techniques can be used, including but not limited to the training techniques described below.

In some embodiments, the foresight learning system 100 prompts the generative model 120 to complete the same task 112 two or more times using two or more different reasoning strategies. All of the completions generated by the model 120 for the task 112 can be assessed by the reward model of the trainer 150 and those assessments can be added to the training data 140, such that the model training process reinforces the reasoning strategies that yield suitable completions and steers the model away from (e.g., does not reinforce) the reasoning strategies that yield unsuitable completions. In this way, the model competes against itself using self-play to produce suitable completions using different reasoning strategies.

In some examples, the trainer 150 trains the generative model using reinforcement learning (e.g., reinforcement learning self-play). In some examples, the trainer 150 finetunes the generative model 120 using direct preference optimization (DPO). When DPO is used, the generative model 120 may generate reasonings related to an event in advance of the event's resolution. Given a question, for example, “What is the probability of Candidate A winning the election?,” the generative model 120 can generate two entirely different reasonings and final outputs (e.g., 80% and 40%). Once the election is decided, the outputs are ranked by correctness (e.g., if Candidate A wins, 80% beats 40%). The model can be finetuned using DPO (for example, using HuggingFace DPOTrainer) on these ranked pairs.

In some examples, the trainer 150 finetunes the generative model 120 using group relative policy optimization (GRPO). When GRPO is used, the generative model may generate reasonings related to an event during training. In this example, the system 100 takes advantage of the fact that a generative model has a “cutoff date” (e.g., the latest publication date of any training data that was used on that generative model) in the past. In this case, the system can make questions about event's using information from the present, starting from the event's resolution. For example, after the election, when it is known that Candidate A has won the election, the system can create the question and answer pair “What is the probability that Candidate A will win the election?” and “100%”. With these question & answer pairs, and using a base generative model with a cutoff date from before the resolutions of the events to which the tasks 112 in the training data relate, the system can run GRPO (for example, using HuggingFace GRPO Trainer). In some examples of GRPO, reasoning threads and answers are generated during training (not before), and answers are ranked by their nearness to the correct resolution.

DPO and GRPO are just two examples of suitable training or finetuning techniques; any suitable technique for training or finetuning generative models (e.g., using reinforcement learning) can be given the training data 140. In some examples, the system explores and optimizes reasoning strategies through self-play. In some examples, “cycles” can be used to compound gains. For example, a model can be trained on one month of data, and the trained model can be used as the base model for the second month of data so that increasingly better reasonings are produced.

In some examples, the system 100 operates in a continuous training loop, allowing for ongoing improvement in reasoning and prediction capabilities. In some examples, a process of training a generative model 120 using foresight learning includes the following steps:
1. The task generator creates a batch of one or more tasks.
2. The generative model 120 produces multiple reasoning processes and predictions for each question. This production of reasoning processes can occur in advance of training (e.g., as in the DPO example above) or during training (e.g., as in the GRPO example).
3. The resolver 130 evaluates the predictions against the outcomes. Sometimes this evaluation is done in parallel with or shortly after the generative model 120 completing a task 112, taking advantage of the past cutoff date of the generative model 120. Other times there may be a gap from when the generative model 120 completes a task and the resolver 130 resolves the task, in which case the resolver 130 use a search-equipped generative model to search for an answer post-resolution.
4. Reasoning processes are scored and ranked accordingly during training based on the accuracy of the predictions produced by those reasoning processes. The system uses these ranked outputs to train the generative model for the next cycle, favoring higher-ranked reasoning processes and strategies.
5. This process repeats continuously, with each cycle potentially improving the capabilities of the generative model 120.

In some examples, this iterative process allows the system to continuously generate increasingly well-reasoned, well-researched, and well-calibrated predictions. By consistently determining which processes produce better outcomes, the system can create more competitive predictions and generate improved training data for subsequent cycles.

Some non-limiting examples of the foresight learning system's operation are now described. In a first example, the task generator 110 uses first context information available on or before a first date/time to generate tasks 112 relating to events that have not resolved as of the first date/time but may resolve on or before a second date/time subsequent to the first date/time. In some examples, the first context information includes information produced (e.g., first made available by the dynamic data source 160) after the cutoff date of the task generator's model and on or before the first date/time. In some examples, the first context information excludes information produced after the first date/time. The generative model 120 can be prompted to complete the tasks 112. In some embodiments, the generative model 120 has a cutoff date on or before the first date/time. In some embodiments, the generative model 120 has access to context information produced on or before the first date/time, but not context information produced after the first date/time. Continuing the first example, the resolver 130 can use second context information available on or before the second date/time to resolve the tasks 112. In some embodiments, the resolver 130 can resolve tasks 112 based on context information produced between the first date/time and the second date/time.

In a second example, the task generator 110 provides tasks 112 to a generative model 120 before the real-world events that are subject of the tasks have been resolved, and the generative model 120 generates completions 122 in response to those tasks before the real-world events that are subject of the tasks have been resolved. This approach may be referred to herein as “online” training. Alternatively, if the events that are the subject of the tasks 112 have not resolved prior to the cutoff date of the generative model 120 and the generative model 120 does not have access to a data source containing data collected contemporaneously with or subsequent to the resolution of the events, the generative model can generate completions 122 in response to the tasks 112 subsequent to the resolution of the events. This approach may be referred to herein as “offline” training.

In a third example, the task generator 110 provides the same task 112 to the generative model 120 multiple times over a time period between the generation of the task 112 and the resolution of the event that is subject of the task. In such cases, the generative model 120 may generate different completions 122 in response to the same task 112 at different times. For example, if the generative model 120 has access to a data source that is updated from time-to-time (e.g., dynamic data source 160), the generative model 120 may generate different completions 122 in response to the same task 112 at different times because the model's reasoning in response to the task may change as the data available to the model changes. In such cases, one or more (e.g., all) instances of a task 112 and a corresponding completion 122 may be used by the resolver 130 to generate training data for the generative model.

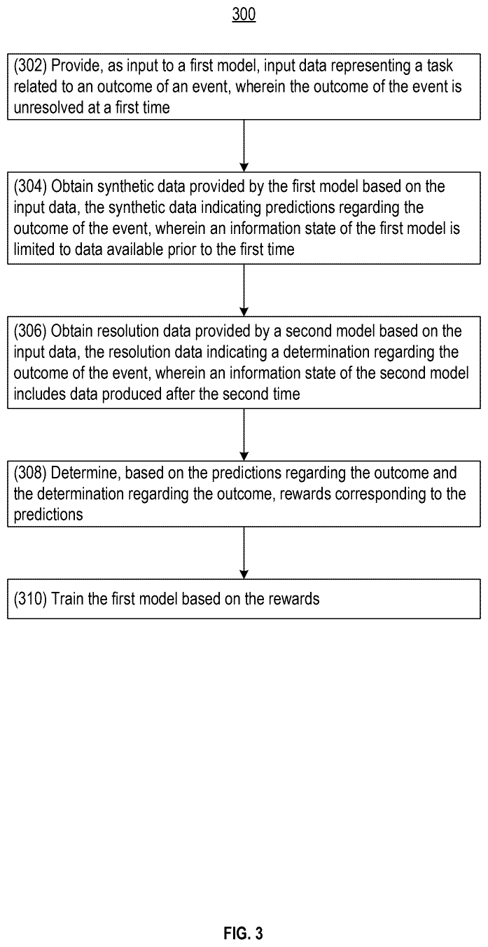

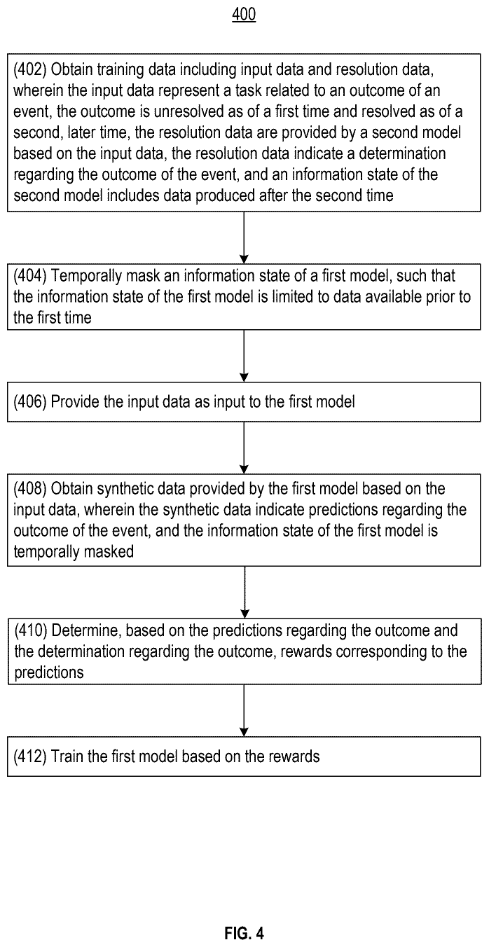

In a fourth example, the task generator 110 generates tasks 112 after the real-world events that are the subjects of the tasks have resolved, and prompts a generative model 120 having a cutoff date prior to the date of the tasks' resolution to complete the tasks. A detailed discussion of offline training techniques is provided in connection with FIGS. 3 and 4.

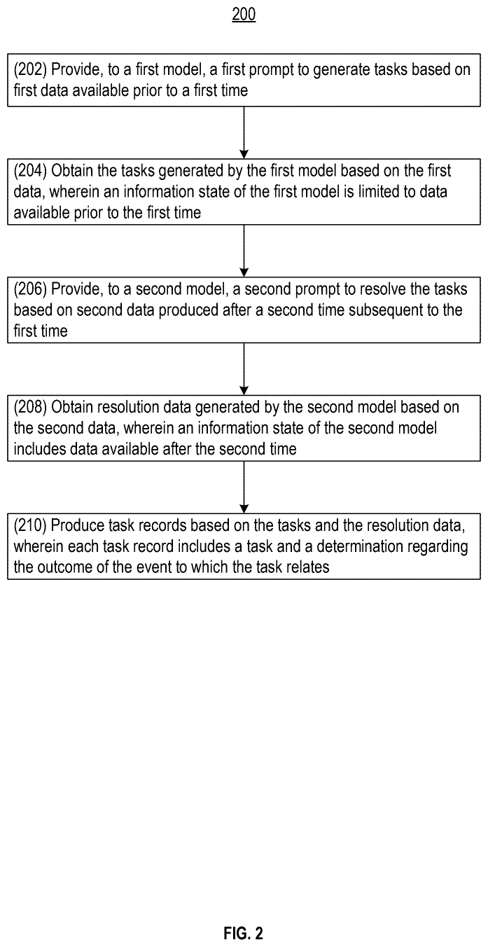

FIG. 2 illustrates an embodiment of a foresight-based data generation method 200. In some examples, the foresight-based data generation method 200 can produce a data set suitable for training or finetuning a model to complete tasks or solve prediction problems related to the unresolved, future outcomes of events. In some examples, the data set can be used to evaluate a model's ability to complete such tasks or solve such prediction problems. In some examples, the foresight-based data generation method 200 can produce such a data set without relying on humans to label or curate the data. In some examples, the foresight-based data generation method 200 can be performed by a system including a task generator 110, a dynamic data source 160, and a resolver 130.

In step 202 of the method 200, a first prompt may be provided to a first model. The first prompt may prompt the first model to generate tasks based on first data available at or prior to a first time. The tasks may relate to outcomes of events. Those outcomes may be unresolved at the first time. The first model may be a generative model. In some examples, each task is a predictive task, such as predicting an outcome of an event (e.g., a real-world event) or generating content related to a predicted outcome of an event.

In some examples, the domain of the events and the first data may be determined based on user input. In such examples, user input identifying a domain for the tasks may be received (e.g., via a user interface). Data records relating to the identified domain may be retrieved from a data source (e.g., dynamic data source 160, a news database, a document database, a Slack message feed, etc.). In some examples, data records of the data source include temporal data (e.g., timestamps) indicating the earliest date on which the content of the data record was available (e.g., published). When the data source is queried for records relating to the identified domain, records having temporal data indicating that they were first available after the first time may be excluded from the results. Alternatively, the data source may include chronologically ordered data records. When the data source is queried for records relating to the identified domain, records having chronological rank indicating that they were first available after the first time may be excluded from the results. In either case, the retrieved data records may be limited to data records first available prior to the first time. In some examples, the first data include the retrieved data records.

In step 204 of the method 200, task data representing the tasks generated by the first model may be obtained. The task data may be generated by the first model based on the first data. When the first model generates the task data, the first model's information state may be limited to data available prior to the first time. The first model's information state may include all data on which the first model has been trained or finetuned, and all context data available to the first model at any time while the model is generating the tasks. Thus, the knowledge cutoff of the first model may be no later than the first time.

In some examples, temporal masking is performed to limit the first model's information state to data available prior to the first time. Such temporal masking may include restricting the first data to include only data records available prior to the first time, preventing the first model from accessing other data records having temporal data (e.g., timestamps) indicating that those records were first available after the first time, and/or preventing the first model from accessing data records having chronological rank indicating that they were first available after the first time.

In step 206 of the method 200, a second prompt may be provided to a second model. The second prompt may prompt the second model to resolve the tasks based on second data. The outcomes of the events to which the tasks relate may resolve by a second time, subsequent to the first time. The second data may include data produced (e.g., first made available) before the first time, after the first time, and/or after the second time. The second model may be a generative model. In some examples, the first model and the second model are the same model.

The second data may include data records retrieved from a data source (e.g., the same data source from which the data records of the first data were retrieved, or a different data source). The retrieved data records may include data records first available prior to the first time, between the first time and the second time, or after the second time.

In step 208 of the method 200, resolution data including determination regarding the outcomes of the events to which the tasks relate may be obtained. The resolution data may be generated by the second model based on the second data. When the second model generates the resolution data, the second model's information state may include data produced after the second time. Thus, the knowledge cutoff of the second model may be later than the second time.

In step 210 of the method 200, task records may be produced based on the tasks and the resolution data. Each task record may include a description of a task and a determination regarding the outcome of the event to which the task relates. In some examples, each task record also indicates the first time (at which the outcome of the event to which the task relates was unresolved) and the second time (by which the outcome of the event to which the task relates had been resolved).

In some examples, the step of producing the task records includes a quality control process. For each potential task record, the quality control process may include steps of (1) determining whether the task satisfies one or more quality criteria; (2) if the task satisfies the one or more quality criteria, adding the task record to a data set; and (3) otherwise, excluding the task record from the data set. In some examples, the quality criteria include a difficulty criterion, which may be satisfied when a difficulty of correctly predicting, at the first time, the outcome of the event to which the task relates exceeds a prediction difficulty threshold. In some examples, the quality criteria include a verifiability criterion, which may be satisfied when a difficulty of verifying, after the second time, the outcome of the event to which the respective task relates is less than a verification difficulty threshold.

In some examples, the quality criteria encourage the selection of task records corresponding to tasks for which there is low confidence in prediction accuracy at the first time, and high confidence in verification accuracy at the second time. In some examples, the quality criteria encourage the selection of task records corresponding to tasks for which there is high confidence in prediction accuracy and an incorrect prediction at the first time, and high confidence in verification accuracy at second time. In some examples, data sets of different difficulty levels can be produced by adjusting the prediction difficult thresholds (or ranges) associated with the quality criteria.

In some examples, the produced task records may be used as training data for training or fine-tuning a generative model to predict outcomes of events, or as evaluation data for testing an ability of a generative model to predict outcomes of events.

FIG. 3 illustrates an embodiment of a foresight-based reinforcement learning (RL) method 300. In some examples, the foresight-based RL method 300 can be used to train or finetune a model to complete tasks or solve prediction problems related to the unresolved, future outcomes of events. In some examples (e.g., “offline” implementations in which the training data are generated prior to initiating the training or finetuning of the model), the foresight-based RL method 300 can be performed by a system including a trainer 150, a generative model 120 (the model being trained or finetuned), and the training data 140. In some examples, training data 140 used in the foresight-based RL method 300 can be generated using a foresight-based data generation method (e.g., the method 200). In some examples (e.g., “online” implementations in which the generation of the training data 140 occurs in parallel with the training or finetuning of the model), the foresight-based RL method 300 can be performed by a system 100.

In step 302, input data representing (e.g., describing) a task related to an outcome of an event are provided as input to a first model (e.g., a predictive model, generative model 120, etc.). The outcome of the event may be unresolved as of a first time. The task may involve providing a prediction (e.g., predicted content) related to the outcome of the event. In some examples, the prediction includes a binary label, a multi-class label, multi-label data, or numeric data characterizing the outcome of the event. For example, the event may be a football game between Team A and Team B on date D. A binary label may indicate whether or not Team A is predicted to win. A multi-class label may indicate whether Team A is predicted to win, lose, or tie. Multi-label data may indicate that Team A is predicted to win and cover the spread. Numeric data may indicate that Team A is predicted to score at least 35 points.

In some examples, the prediction includes text data, image data, audio data, or video data related to (e.g., characterizing) the predicted outcome of the event. For example, a prediction may include text data describing the dress that Taylor Swift is predicted to wear to the Grammy Awards in 2027 or image data depicting the dress that Taylor Swift is predicted to wear to the Grammy Awards in 2027. As another example, a prediction may include audio data representing the predicted sound of a throat surgery patient saying their name one month after surgery, or video data depicting a knee surgery patient's predicted gait three months after surgery.

In step 304, synthetic data provided by the first model based on the input data are obtained. The synthetic data (e.g., machine-synthesized data; output of a predictive or generative model; etc.) may indicate one or more predictions regarding the outcome of the event. In some examples, when the first model generates the synthetic data, the first model's information state may be limited to data available prior to the first time.

In step 306, resolution data provided by a second model (e.g., resolver 130) based on the input data may be obtained. The resolution data may indicate the second model's determination regarding the outcome of the event to which the task relates. The outcome of the event may be resolved by a second time (later than the first time). In some examples, when the second model generates the resolution data, the second model's information state may include data available after the second time.

In some examples, steps 302-306 of the method 300 are performed in an “online” implementation with the temporal and causal structure of real-world prediction, such that the synthetic data are provided by the first model prior to the first time, and the resolution data are provided by the second model after the second time. In some examples, steps 302-306 of the method 300 are performed in an “offline” implementation lacking the temporal and causal structure of real-world prediction, such that the resolution data are provided by the second model before the input data are provided as input to the first model, and the information state of the first model is temporally masked.

In step 308 of the method 300, rewards (values used for model-training) are determined based on the one or more predictions regarding the outcome of the events and the corresponding determination regarding the outcome of the event. Some non-limiting examples of techniques for determining rewards are described below. Each of the rewards may include a value determined based on an accuracy of a prediction of the first model.

In step 310 of the method 300, the first model is trained based on the rewards. Training the first model may include updating a policy of the first model based on a reinforcement learning algorithm and the rewards. In some examples, the reinforcement learning algorithm is a group relative policy optimization (GRPO) algorithm, a modified GRPO algorithm, a ReMax algorithm, or a Direct Preference Optimization (DPO) algorithm.

In some examples, each prediction provided by the first model in step 304 indicates a predicted probability p of the event's occurrence. In some examples, the determination regarding the outcome of the event includes a binary value y indicating whether the event occurred. In such examples, the value of the reward may be y*log(p)+(1−y)*(1−log(p)). Thus, when the binary value indicates that the event occurred, the reward corresponding to a prediction may be based on a logarithm of the probability value of the respective prediction (e.g., reward value=log(p)). Alternatively, when the binary value indicates that the event did not occur, the value of the reward may be based on a logarithm of a complement of the probability value of the respective prediction (e.g., reward value=log(1−p).

In some examples, the predictions regarding the outcome of the event may include prediction data characterizing the outcome of the event and a probability value p (or confidence value) indicating a probability (or confidence) that the prediction data are correct. Likewise, the determination regarding the outcome of the event may include determination data characterizing the outcome of the event. In such examples, determining the value of a reward corresponding to a prediction may include (1) determining a correctness value c indicating a correctness of the prediction based on the prediction data and the determination data; (2) determining a first reward term based on the correctness value and a logarithm of the probability value of the prediction; (3) determining a second reward term based on a complement of the correctness value and a logarithm of a complement of the probability value of the prediction; and combining the first reward term and the second reward term.

In some examples, the first reward time is c*log(p), the second reward term is (1−c)*log(1−p), and the value of the reward is c*log(p)+(1−c)*log(1−p). The correctness value c may be a numeric value between 0.0 and 1.0, inclusive. In some examples, determining the correctness value includes assessing a similarity of the prediction data to the determination data.

Any suitable techniques may be used to assess the similarity of the prediction data and the determination data. In some examples, a model (e.g., generative model) is used to judge the similarity of the prediction data and the determination data. Such a model may be referred to herein as a “judge.” Irrespective of the data type of the prediction data and the determination data (e.g., text, image, video, numeric, etc.), the judge can assign a similarity score using a rubric.

Alternatively, type-specific similarity metrics may be sued. For example, for text data, image data, audio data, and/or video data, any suitable similarity metrics specific to those data types may be used. For binary labels, the Brier score may be used as a measure of similarity. For numeric data, the squared distance or logarithmic distance between the predicted and determined values may be used as a measure of similarity. Alternatively, given a predicted distribution, the probability density of the predicted distribution at the determined value may be used as a measure of similarity. Many other examples are possible.

FIG. 4 illustrates an embodiment of a foresight-based reinforcement learning (RL) method 400. In some examples, the foresight-based RL method 400 can be used to train or finetune a model to complete tasks or solve prediction problems related to the unresolved, future outcomes of events. In some examples (e.g., “offline” implementations in which the training data are generated prior to initiating the training or finetuning of the model), the foresight-based RL method 400 can be performed by a system including a trainer 150, a generative model 120 (the model being trained or finetuned), and the training data 140. In some examples, training data 140 used in the foresight-based RL method 300 can be generated using a foresight-based data generation method (e.g., the method 200).

In step 402 of the method 400, training data (e.g., training data 140) are obtained. The training data may include input data and resolution data. The input data may represent (e.g., describe) a task related to an outcome of an event (e.g., real-world event). The outcome of the event may be unresolved as of a first time and resolved as of a second time later than the first time. The resolution data may be provided by a second model based on the input data, and may indicate a determination regarding the outcome of the event. When generating the resolution data, an information state of the second model may include data produced after the second time.

In some examples, obtaining the input data includes (1) extracting context data related to the event from one or more first data records of a data source, wherein each of the one or more first data records includes a timestamp earlier than the first time; (2) prompting a generative model to generate the task regarding the outcome of the real-world event based on the extracted context data; and (3) obtaining, from the generative model, the task. Other techniques for obtaining temporally masked input data related to an event or domain may be used, including but not limited to the techniques described herein.

In step 404 of the method 400, an information state of the first model is temporally masked, such that the information state of the first model is limited to data available prior to the first time.

In step 406 of the method 400, the input data are provided as input to the first model.

In step 408 of the method 400, synthetic data provided by the first model based on the input data are obtained. The synthetic data may indicate one or more predictions regarding the outcome of the event. When generating the synthetic data, the information state of the first model may be temporally masked.

In step 410 of the method 400, one or more rewards corresponding to the predictions may be determined based on the predictions regarding the outcome and the determination regarding the outcome.

In step 412 of the method 400, the first model may be trained or finetuned based on the rewards.

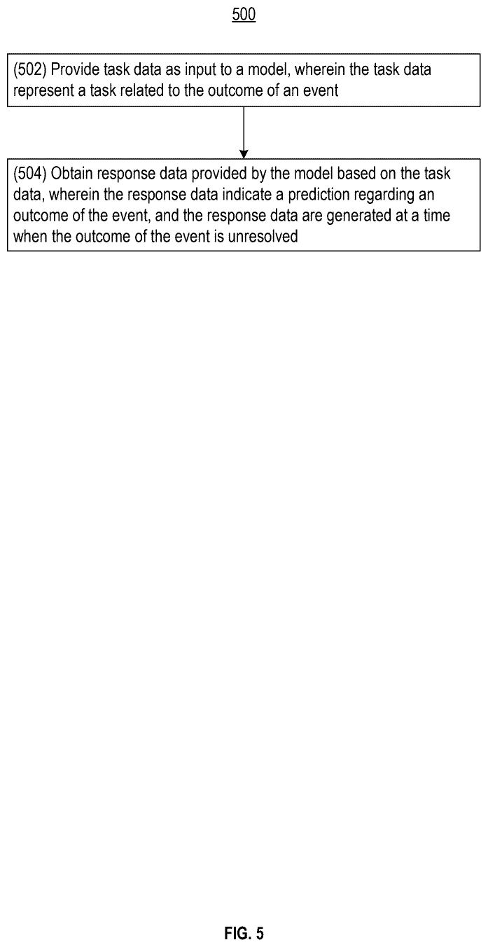

FIG. 5 illustrates an embodiment of a predictive method 500. In some examples, the predictive method 500 can be used to complete tasks or solve prediction problems related to the unresolved, future outcomes of events. In some examples, the predictive method 500 is performed by a generative model 120. In some examples, the generative model 120 has been trained or finetuned using a foresight-based training method (e.g., the foresight-based training method 300 or 400). In some examples, the generative model 120 has been trained or finetuned using training data 140 generated using a foresight-based data generation method (e.g., the method 200) and any suitable training or finetuning algorithm.

In step 502 of method 500, task data are provided as input to a model. The task data may represent (e.g., describe) a task related to the outcome of an event. In step 504 of method 500, the model generates response data indicating a prediction regarding an outcome of the event. The response data may be generated based on the task data. The response data may be generated at a time when the outcome of the event is unresolved.

In some examples, the model has been trained, using a reinforcement learning algorithm, training data, and one or more rewards, to generate predictions regarding outcomes of events. For example, the model may have been trained using method 300 or method 400.

### EXAMPLES

Described below are some examples and applications of some embodiments. It should be understood that these examples are informative and not limiting.

### Example 1: Foresight-Based Data Generation and Foresight Learning with Self-Play

In some examples, data sets produced using the foresight-based data generation techniques can be used to facilitate the training of generative models via self-play or other suitable training techniques. Training generative models via self-play can help to scale the training and enhance the domain applicability of generative models.

Background: Self-Play is a training method in which an AI model (e.g., generative model) interacts with itself to generate training data and improve its capabilities. An example of self-play is AlphaGo, where an LLM plays Go against itself repeatedly. Self-play creates a virtuous cycle of learning: as more games are played, more training data is generated, the model gets smarter, gameplay improves, so training data improves, so model gets even smarter, etc. Self-play can be used to teach generative models (e.g., LLMs) to reason by providing curated question-answer pairs, letting the generative model (e.g., LLM) make many attempts at reasoning its way to the answer from the question, and then learning from which reasoning threads did the best.

Problem: Self-play involves verifiable tasks (e.g., tasks for which the suitability (e.g., correctness) of the completion of the task can be verified with high degrees of objectivity and certainty). The production of training data involving verifiable tasks can be a major bottleneck. A verifiable task can be a game that can be simulated, where there is a clear winner. Curated questions with known answers are also verifiable, because the correctness of the answer can be checked. Certain kinds of coding problems are verifiable, if you can automatically verify that the code is doing what it is meant to do. In some examples, foresight-based data generation can make real world reasoning a verifiable task, without human curation.

Insight: Verification is generally easier than prediction. For example, there are many questions that generative models (e.g., LLMs) today are capable of answering, after the fact. For example, Perplexity or ChatGPT with Search can tell you who won the Super Bowl the day after the Super Bowl, or who won the election weeks after the election.

Application: Foresight-based data generation transforms any live stream of data into verifiable tasks that can be used to train AI models via self-play. One example of a data stream is the entire internet, but other data streams are possible. Foresight-based data generation takes advantage of the fact that verification is easier than prediction.

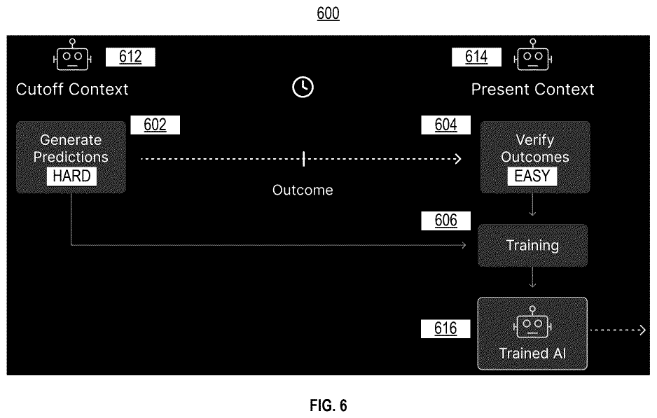

FIG. 6 illustrates a non-limiting example of an online, foresight-based data generation process 600. “Online” data generation may refer to data generation processes in which tasks relating to the outcomes of events are generated before those outcomes are resolved, and the outcomes of the events are determined later, after the events resolve. In some examples, the foresight-based data generation process 600 includes automatically generating 602 many questions to which a generative model 612 does not know the answers, because the outcomes have not yet occurred. These questions can be difficult to predict the answer to, but not difficult to resolve once they have occurred. In some examples, the process 600 further includes automatically resolving 604 the answers to those questions, once the outcomes have occurred, using the same model 612 (or a different model 614) with access to data produced after the outcomes occurred, via the Internet or other data sources). In some examples, in step 606, the automatically generated questions and answers can be used to train a generative model (e.g., the generative model 612 or 614) via self-play or any other suitable training technique, thereby producing an improved generative model 616.

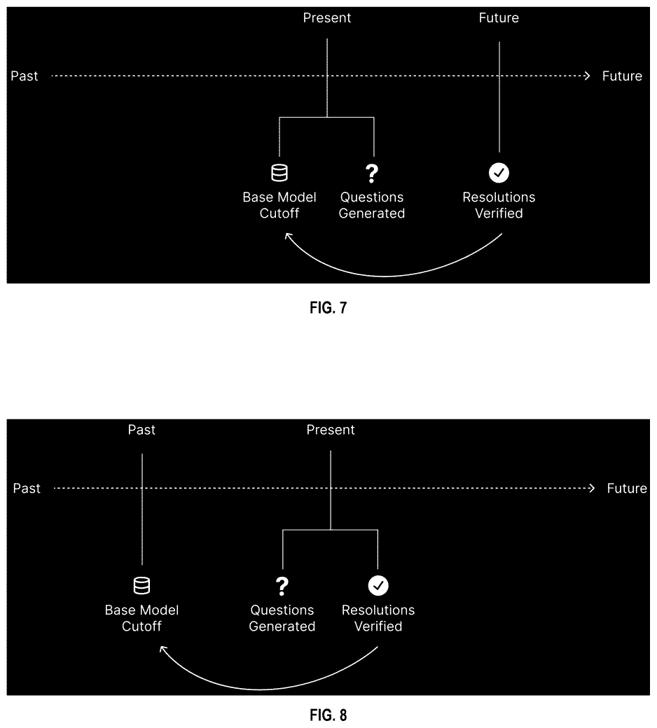

FIG. 7 illustrates the temporal structure of an online, foresight-based data generation process, wherein the question-generating model 612 has a cutoff date before the present time, the question-generating model 612 generates questions about the future at the present time, and the answer-resolving model 614 resolves the answers to those questions in the future, after the events to which the questions relate have resolved.

FIG. 8 illustrates the temporal structure of an offline, foresight-based data generation process. “Offline” data generation may refer to data generation processes in which tasks relating to the outcomes of events are generated after those outcomes are resolved, and the outcomes of the events are determined simultaneously or in parallel with generating the tasks. In the example of FIG. 8, the question-generating model 612 has a cutoff date in the past, the question-generating model 612 generates questions about events that resolved after the cutoff date but before the present time (using only data available as of the model's cutoff date), and the answer-resolving model 614 resolves the answers to those questions in the present, after the events to which the questions relate have resolved. Offline, foresight-based data generation can simplify the data generation process by taking advantage of the fact that generative models today have cutoff dates in the past—so the knowledge that a generative model has access to is already in the past. This temporal structure allows us to generate question and answer pairs in a single step, in the present, but present them to a generative model with a cutoff date in the past as verifiable tasks.

Foresight-based data generation processes may scale indefinitely (hypothetically creating many billions of questions and answers a day using data obtained via the Internet as context) and across domains (this method can be applied to any stream of data). It is also not dependent on any specific learning algorithm or even on any specific AI architecture. For an example of an applicable learning approach, see Turtel et al., “LLMs can teach themselves to better predict the future,” Feb. 7, 2025, available at https://arxiv.org/pdf/2502.05253, which is hereby incorporated herein by reference in its entirety.

In addition to scale, there are many important advantages to foresight-based data generation and foresight learning over traditional methods:
1. Making predictions about the future trains probabilistic thinking. LLMs today are generally very bad at knowing whether they know the answer confidently versus whether they are making a guess. Forecasting the future involves thoughtful calibration of the likelihood of various events. Indeed, in some embodiments forecasting the future involves directly optimizing Brier scores (by asking the model to output probabilities for likelihood of various outcomes). Even just learning what cannot be said with confidence is incredibly useful.
2. Predicting the future involves distinguishing between trustworthy and untrustworthy content. Entire industries of SEO (search engine optimization) and now AEO (answer engine optimization) benefit from the fact that AI does not naturally optimize for understanding which content is trustworthy. Foresight learning solves this problem directly, as trustworthy information has higher predictive power than untrustworthy information. It rewards finding the right information from the current state of the world.
3. Finally, for online foresight-based data generation processes and for offline foresight-based data generation processes with appropriate temporal masking, the future is always out of sample—there is no chance of dataset poisoning. This is very difficult for most types of problems, and indeed most AI benchmarking solutions either work hard to constantly produce new questions (that are not on the internet) or go to great lengths to avoid their questions being exposed to the internet.

Foresight learning has the potential to massively disrupt the training of AI by solving the human bottleneck. This disclosure describes a framework for scaling the generation of verifiable question-answer pairs suitable for training AI models via foresight learning on real world outcomes, at scale, without humans in the loop or human-curated labels. Aspects of foresight learning are based on the fundamental understanding that prediction is a core purpose of reasoning and inference.

When an AI model is trained to mimic a dataset, the best it can learn is the patterns contained within that dataset. If the AI model is trained on text, or high-quality reasoning processes from humans, the best it can learn is to approximate, but never surpass, those processes. One approach to achieving superhuman capabilities—to learning something fundamentally new—is for AI to explore new strategies outside of its training set, and learn from ground-truth feedback of which strategies work best.

This kind of self-play can be effective in training generative models with a curated set of question and answer pairs. However, the use of a curated set of question and answer pairs poses significant problems, as this approach involves human curation of question and final answer pairs and relies on exclusion of the answers from the base model's training data, which typically includes a huge amount of content available on the internet.

Foresight learning (e.g., online foresight learning or offline foresight learning with appropriate temporal masking) allows this framework to scale by automatically generating questions about the future and automatically assigning the resolutions for those questions. Importantly, questions about unresolved outcomes of future events are questions that do not have certain answers within the base model's training data.

By training a generative model directly on its predictive capabilities, some embodiments excel at increasing the model's intelligence: the ability to make well-reasoned inferences about unknown information and future events.

Some aspects of some embodiments of foresight-based data generation and foresight learning with self-play are described in further detail below.

AI models (e.g., generative models) today use huge amounts of curated training data to learn, and models have already been trained on most data available on the internet. Even existing methods that leverage self-play use curated question-answer pairs, to be able to determine which of the reasoning threads generated by a model are better or worse.

The use of curated question-answer pairs presents several limitations, including limitations relating to a human bottleneck, social optimization, and a ceiling on model capabilities.

Human Bottleneck: The quality and quantity of training data are constrained by human review capacity, limiting the scale and speed of improvement.

Social Optimization: Models are trained to produce agreeable or plausible-sounding responses based on social feedback, rather than learning to form and test hypotheses or optimize for factual accuracy.

Ceiling on Capabilities: At best, these methods can lead to models that reason as well as humans, but not significantly better.

These limitations fundamentally hinder models' ability to make well-calibrated predictions about future events and engage in superior reasoning. Additionally, while many AI models are optimized to retrieve specific information over documents (for example, using retrieval augmented generation (RAG)), there is no clear way to reward models for judging which information is trustworthy, and how much to allow answers to be influenced by a given source.

Despite these limitations, even some existing generative models (e.g., LLMs) can perform comparably to human forecasters in prediction tasks. This level of performance indicates significant potential for improvement if AI models were trained directly for reasoning and prediction, using methods that transcend current human-centric approaches. Notably, in domains where AI applications have achieved superhuman capabilities-such as AlphaGo in the game of Go—the breakthrough came through self-play mechanisms. These approaches allow AI applications to generate an increasingly high-quality dataset of training data by competing against itself, free from the constraints of human bottlenecks. Similarly, foresight learning also can be very effective at training generative models (e.g., LLMs), and foresight-based data generation techniques can provide question and final answer pairs for model training without relying on human curation.

As described above, generative models (e.g., LLMs) today generally rely on human-curated data for learning. Foresight learning with self-play flips this approach on its head. Instead of giving the AI model high-quality examples to mimic, foresight learning with self-play provides a framework within which the AI model can compete against itself to predict real-world outcomes at scale. This framework enables a learning process similar to self-play in the domain of reasoning and prediction.

In some examples, foresight learning with self-play introduces new ground-truth information into the training process for a model to learn something new. Existing approaches are fundamentally bottlenecked by the existing set of human knowledge and capabilities. Removing these bottlenecks so that AI models can learn directly from real-world outcomes is what enables self-play at scale, potentially resulting in superhuman capabilities.

For example, in AlphaGo, the model is able to learn beyond the best human examples because simulated gameplay introduces new ground-truth information—the actual outcome of games. As AI improves, training samples get better-based on actual ground-truth outcomes in Go, not from AI or human estimates of performance. This approach scales because games can be simulated, but scaling is more difficult when making predictions that need to be verified via real world outcomes. The new ground truth in foresight learning is real world outcomes.

Foresight learning with self-play can avoid bottlenecks in the following ways.
1. Questions are generated at scale from any data stream, including the internet itself. Generative models can use existing context to generate questions that are difficult to answer currently, but that the generative model can answer easily in the future. In other words, foresight learning techniques can use the gap between present and future knowledge—constantly trying to model the future state from the present—as a scalable and cross-domain reward function for training generative models.
2. With foresight learning, “labels” are real world outcomes. AI models are predicting events in the real world (for example: “Will Ukraine hold a position in Kursk through October 31?” “Will Kamala Harris win the presidency?” “Will the Jets beat the 49ers?”).
3. Competitive self-play results in multiple reasoning processes for each question, before outcomes are known. AI is later trained on ranked sets of these reasoning processes, based on those real world outcomes. This outside information—not human preferences or estimates by the generative model—are the labels being modeled, introducing new information into the training process.

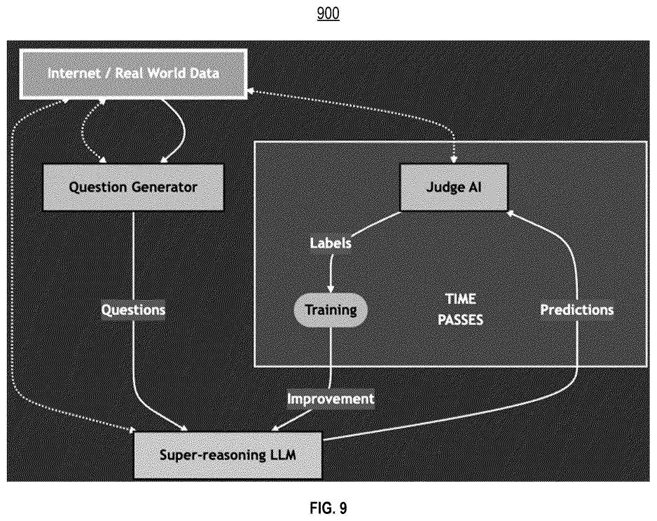

FIG. 9 shows a block diagram of a system 900 for foresight learning with self-play. In some embodiments, foresight learning with self-play involves the following tasks:
1. Foresight-based question generation. The generation of high-quality questions at scale by AI for training (this is kind of like the board in a boardgame). This process can scale indefinitely to millions or even billions of questions every day, without humans in the loop.
2. Evaluation of winner. The ability for a model (e.g., “Judge AI”) to determine, again at scale, which prediction was most correct. The Judge AI can reasonably reliably research and report on outcomes by searching the internet, after an outcome has come to pass. Given a set of AI-generated answers to a question, this Judge AI can determine which AI had predicted outcomes most accurately.
3. Self-play generated reasoning & predictions. Existing algorithms like Direct Preference Optimization (DPO)/Group Relative Policy Optimization (GRPO) can be used.

These 3 attributes, combined, can enable a limitless, scalable, and competitive self-play on a game of real-world prediction. The “labels” are the real world outcomes, later determined by the Judge AI. Competitive self-play results in multiple reasoning processes for each question, before outcomes are known. A generative model is later trained on ranked sets of these reasoning processes, based on those real world outcomes. This outside information—not human preferences or estimates by the generative model—are the labels being modeled, introducing new information into the training process.

### Example 2. Experimental Data

Experiments demonstrate that foresight learning techniques can significantly improve the probabilistic calibration of AI (e.g., generative models). Using the same data and models from Turtel et al., “LLMs can teach themselves to better predict the future,” Feb. 7, 2025, available at https://arxiv.org/pdf/2502.05253, experimental results demonstrate that foresight learning techniques can significantly reduce expected calibration error (ECE). ECE essentially measures how well the predicted output probabilities of a model match the actual probabilities of outcomes assigned to those predicted probabilities (e.g., when the model predicts 30% likelihood, such events should actually happen 30% of the time). Lower ECE scores are better.

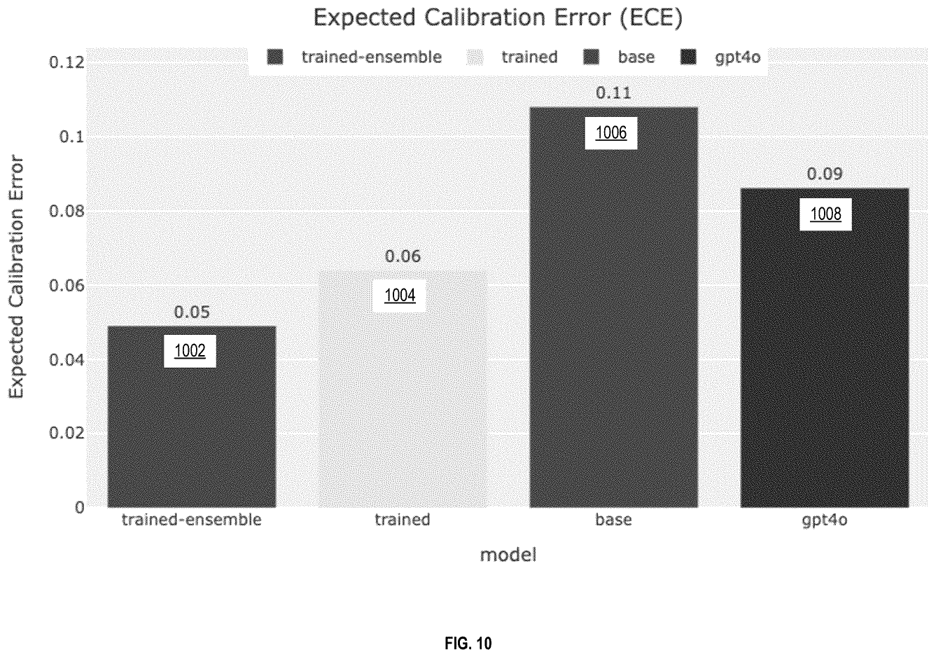

FIG. 10 illustrates expected calibration error (ECE) of four models. In FIG. 10, the bar 1006 indicates the ECE of the base model, the bar 1004 indicates the ECE of the trained model (trained with foresight learning techniques), the bar 1002 indicates the ECE of a trained ensemble model (trained with foresight learning techniques) taking the median of 5 predictions, and the bar 1008 indicates the ECE of the GPT-40 model as a benchmark. As can be seen, the ECE of the trained model is 45% lower than the ECE of the base model and 33% lower than the ECE of the GPT-40 model. The ECE of the trained ensemble model is approximately 16% lower than the ECE of the trained individual model.

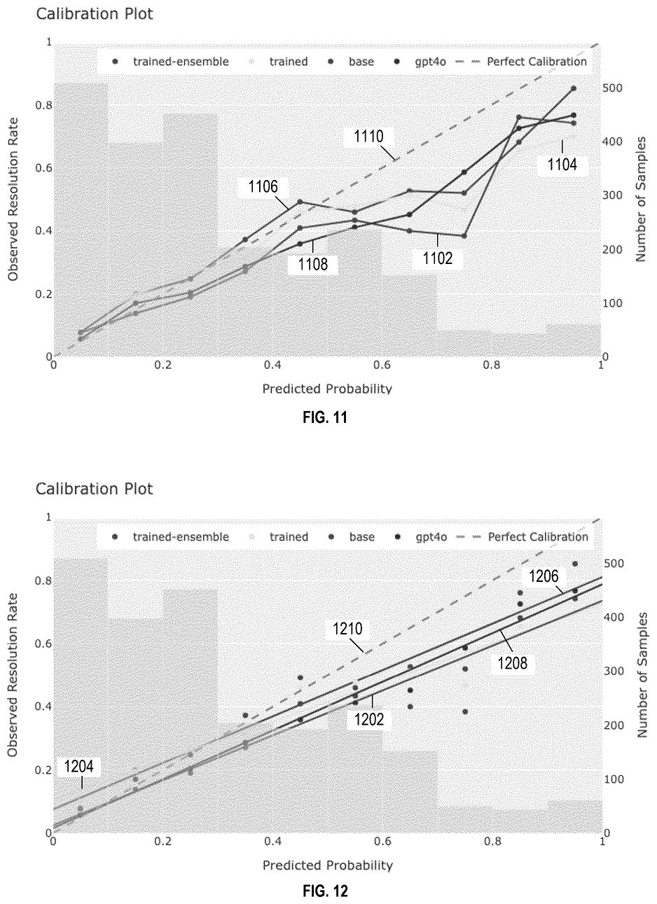

FIG. 11 is a line graph illustrating calibration values for the four models of FIG. 10 across a range of predicted probabilities; FIG. 12 shows trend lines fitted to the calibration values of FIG. 11. Both FIG. 11 and FIG. 12 are referred to herein as “calibration plots.” In the calibration plots of FIGS. 11 and 12, lines 1106 and 1206 illustrate calibration values for the base model, lines 1104 and 1204 illustrate calibration values for the model trained with foresight learning, lines 1102 and 1202 illustrate calibration values for the ensemble model trained with foresight learning, lines 1108 and 1208 illustrates calibration values for the GPT-40 model as benchmark, and lines 1110 and 1210 illustrate perfect calibration values (calibration values for a model that perfectly predicts the probability of events' occurrence). In addition, the bars in each of the calibration plots indicate the number of training samples in the training data for the trained models for which the observed probability of the event to which the training sample relates falls within various ranges (e.g., 0.0-0.1, 0.1-0.2, 0.2-0.3, and so on). The calibration plots of FIGS. 11 and 12 show that the models trained with foresight learning techniques exhibit calibration values substantially closer to the “perfect calibration” line than the base model or GPT-40. The calibration plots also show that the calibration values of the models trained with foresight learning techniques are strongly correlated with the number of training samples in each range (or “bucket”) of probabilities, suggesting that as the number of training samples in each bucket increases, the performance of the models trained using foresight learning continues to improve, resulting in even better probabilistic calibration.

Additional experiments have demonstrated that, overall, predictions even on a small 14B parameter model trained with 10,000 examples of foresight learning techniques are overall more accurate than frontier models like GPT-40. A head-to-head comparison of the same trained model and GPT-40 demonstrates that the predictions of the model trained using foresight learning were better than or tied with GPT-4o 65% of the time, beat GPT-4o's prediction 50% of the time, tied 15% of the time, and lost only 35% of the time.

### Example 3. Foresight-Based Data Generation

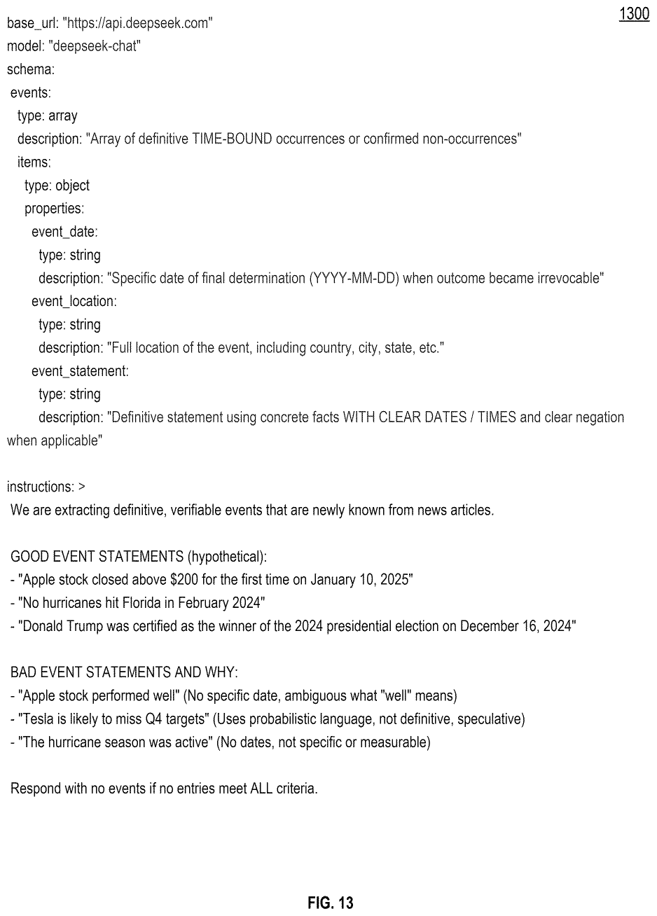

An example foresight-based data generation process is described below. This example process is one example of the foresight-based data generation method 200 described above, and can be used to generate tasks 112 and resolution data 132 at scale. In some embodiments, one or more steps of this example process are implemented using the prompts illustrated in FIGS. 13-17. Other prompts and other implementations are possible.

In this example, the data produced using the example foresight-based data generation process are intended for use in training a base model with a historical cutoff date of 12 months ago. The data generation process relies on news events that occur (or resolve) on dates between the model's cutoff date and the present date to generate task-outcome (e.g., question-answer) pairs with which to train the model.

In these examples, prompts to a generative model (e.g., a generative model of a task generator 110 and/or a resolver 130) are formatted as Sculptor templates. Sculptor is an open source library suitable for structuring unstructured data, and for building data pipelines that leverage generative models (e.g., LLMs). The Sculptor library is available at https://github.com/lightning-rod-labs/sculptor.

In a first step of the example foresight-based data generation process, diverse news stories having publication dates between the cutoff date and the present date are fetched. In some examples, such fetching may be performed in step 202 of the data-generation method 200. Although any suitable techniques may be used to fetch the news stories, some example implementations may involve: (1) identifying the most widely reported events and associated articles that reported those events (e.g., using GDELT API (https://www.gdeltproject.org/)); (2) randomly generating queries using a topic tree (e.g., a Pluto (https://github.com/redotvideo/pluto) topic tree) and pairing those queries with the names of locations (e.g., locations of events), and finding matching news stories (e.g., using Exa (https://exa.ai/) with date filters); and/or selecting random articles from any given week (e.g., using Gnews (https://gnews.io/)).

In a second step of the example foresight-based data generation process, event statements are extracted from articles. In some examples, such extraction may be performed in step 204 of the data-generation method 200. In some examples, the extracted event statements are concrete, unambiguous, and verifiable. In some examples, starting from each article, the system extracts concrete, unambiguous, verifiable event statements that could have been used to create prediction market questions before the event occurred. An example of a prompt 1300 (e.g., Sculptor template) suitable for extracting such event statements is shown in FIG. 13. In some examples, by construction, all event statements extracted in this step of the example process are true statements (questions that resolve to “Yes”).

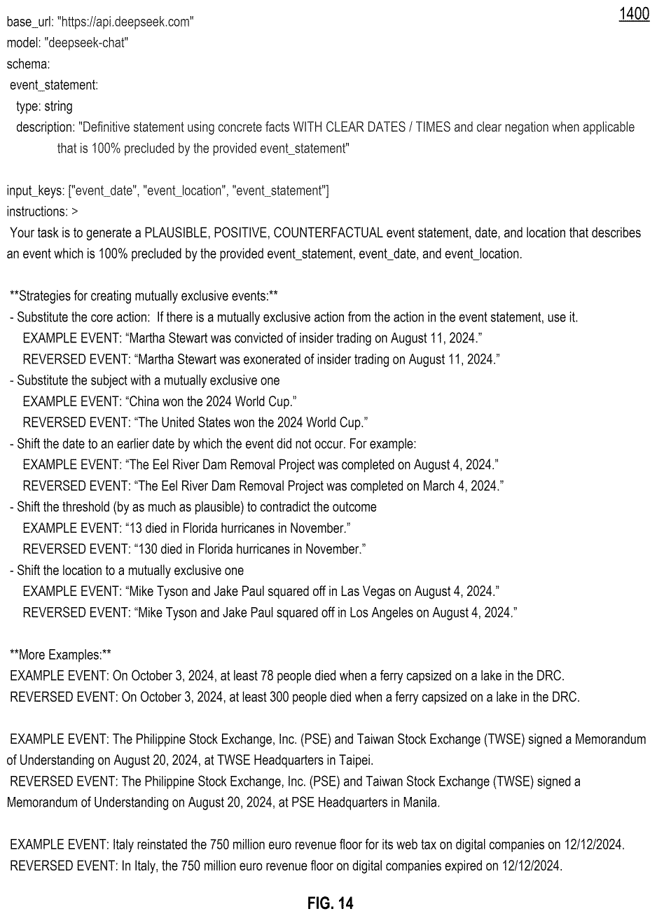

In an optional third step of the example foresight-based data generation process, one or more event statements are mutated to create a set of event statements having a desired ratio (e.g., equal number) of True event statements and False event statements (questions that resolve to “No”). In some examples, such mutation may be performed in step 204 of the data-generation method 200. An example of a prompt 1400 (e.g., Sculptor template) suitable for mutating True event statements into False event statements is shown in FIG. 14.

In an optional fourth step of the example foresight-based data generation process, one or more event statements satisfying one or more criteria may be selected from the set of event statements. This step may be referred to as a “filtering” step. In some examples, such filtering may be performed in step 204 of the data-generation method 200.

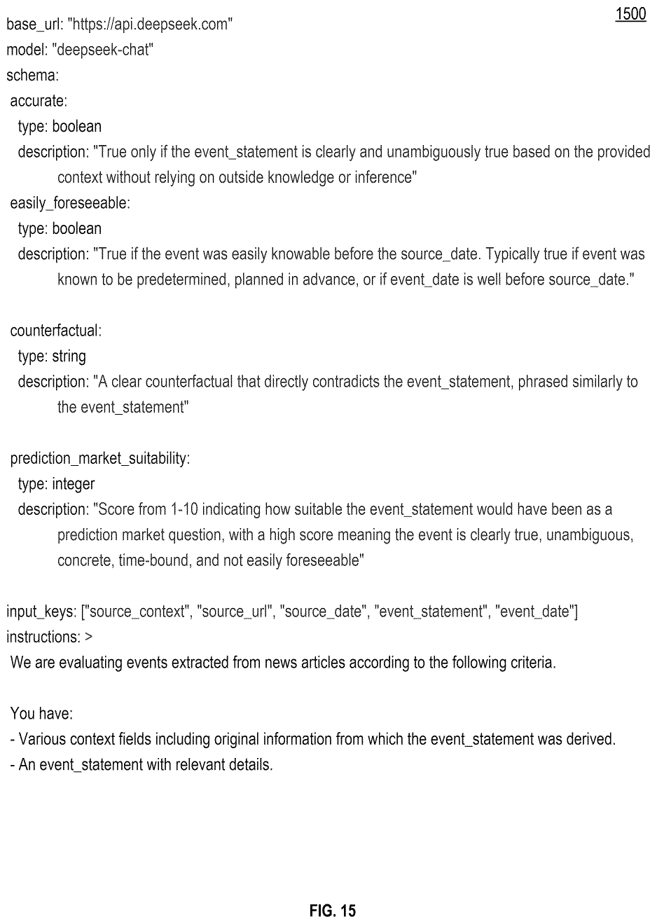

Any suitable filtering criteria may be used. In some examples, the purpose of the filtering is to select event statements corresponding to task/outcome pairs (e.g., question/answer pairs) that are suitable for training a model to predict outcomes of future events, or suitable for benchmarking the ability of a model to predict outcomes of future events. In some examples, an event statement satisfies the criteria for selection if (1) based on the data fetched in the first step of the process, a model resolves the outcome of the event with high confidence (e.g., the model's confidence that it has correctly resolved the outcome of the event exceeds a first confidence threshold), and (2) based on data published no later than a model's cutoff date, the model predicts the outcome of the event with low confidence (e.g., the model's confidence that it has correctly predicted the outcome of the event is less than a second confidence threshold). Filtering the event statements in this manner can ensure that models are trained (or evaluated) on difficult-to-predict reasoning tasks and that the outcomes of the events to which those tasks pertain are unambiguous. An example of a prompt 1500 (e.g., Sculptor template) suitable for selecting high-quality market event statements is shown in FIG. 15.

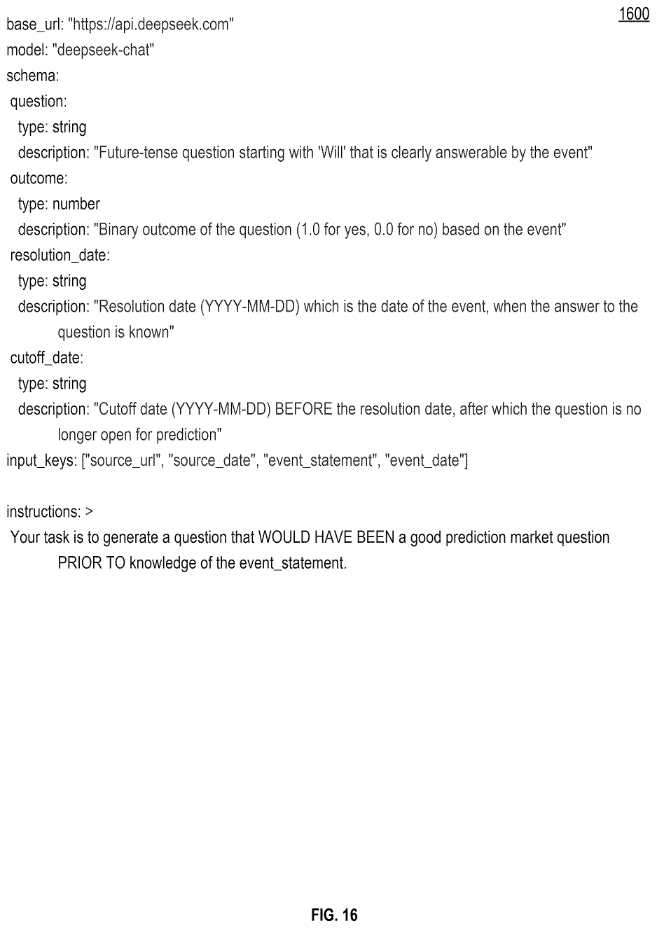

In a fifth step of the example foresight-based data generation process, past-tense event statements among the set of event statements are transformed into prediction tasks (e.g., prediction questions, such prediction market questions). For example, past tense event statements such as “Candidate A won the election in 2024” can be transformed into prediction questions such as “Will Candidate A win the election in 2024?” In some examples, such transformation may be performed in step 204 of the data-generation method 200. An example of a prompt 1600 (e.g., Sculptor template) suitable for transforming past-tense event statements into prediction tasks (e.g., prediction questions) is shown in FIG. 16.

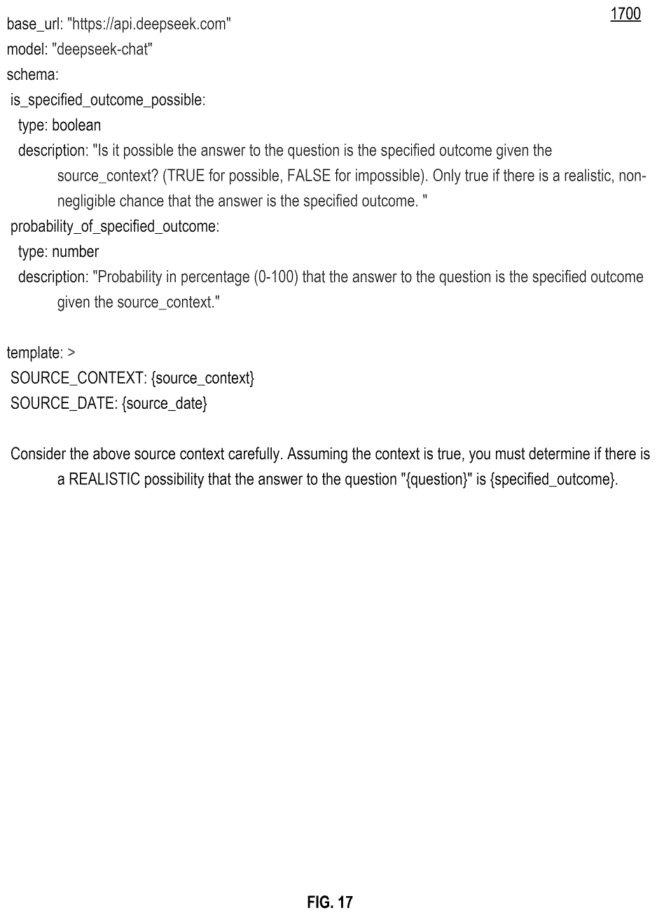

In an optional sixth step of the example foresight-based data generation process, one or more task/outcome pairs satisfying one or more criteria may be removed from the data set. This step may be referred to as a “quality assurance” step. Any suitable criteria may be used to remove task/outcome pairs from the data set. In some examples, a task/outcome pair is removed is the model determines that it is impossible or highly unrealistic for the indicated outcome to be the actual outcome of the event to which the task relates. In some examples, such quality assurance checking may be performed in step 204 of the data-generation method 200. An example of a prompt 1700 (e.g., Sculptor template) suitable for performing a quality assurance check on task/outcome pairs is shown in FIG. 17.

### Example 4. Foresight Learning with DPO

An example foresight learning process is described below. This example process is one example of the foresight learning method (e.g., method 300 or 400) described above, and can be used to train a generative model to solve prediction tasks. The example process can be used to train a generative model on the data set produced by the foresight-based data generation process of Example 3. The model being trained may be referred to in Example 4 as a “base model,” and the data set on which the base model is trained may be referred to as a “training data set.” In some examples, the base model has a cutoff date of 12 months ago.

In a first step of the example foresight learning process, the base model generates two different completions for each task in the training data set. In some examples, the production of completion(s) by the base model may be performed in step 304 of the foresight learning method 300 or in step 408 of the foresight learning method 400. Each completion may include a prediction (e.g., predicted probability of an event occurring, predictive content, etc.) and a representation of the reasoning used by the base model to produce the prediction. Two completions may be considered “different” if the predictions included in the completions are different. In some examples, if the base model initially produces two completions with the same predictions, the base model may be prompted to produce additional completions for the same task until a different completion is produced.

In a second step of the example foresight learning process, the base model is finetuned using direct preference optimization (DPO). In some examples, the finetuning of the base model may be performed in step 310 of the foresight learning method 300 or in step 412 of the foresight learning method 400. Finetuning the base model using DPO may involve, for each task in the training data set, evaluating the two different completions generated by the base model, determining which of the completions is more suitable (e.g., more accurate) based on the outcome of the task recorded in the training data set, and finetuning the model to prefer the reasoning process that produced the more suitable completion using DPO. In some examples, the DPO finetuning is performed using HuggingFace's DPOTrainer.

In a third step of the example foresight learning process, the base model and the finetuned model may be evaluated and the evaluation results may be compared. Any suitable technique may be used to evaluate the models. In some examples, the models are submitted to a HuggingFace Leaderboard and evaluated on standard benchmarks. In some examples, a subset of the task/outcome pairs generated in Example 3 are reserved as a test data set, and each model's accuracy is evaluated over that test data set.

### Example 5. Foresight-Based Reinforcement Learning with Verifiable Rewards

Example foresight learning processes are described below. Each of these example processes is an example of the foresight learning method (e.g., method 300 or 400) described above, and can be used to train or finetune a generative model to solve prediction tasks.

Reinforcement Learning with Verifiable Rewards (RLVR) has been an effective approach for improving Large Language Models' reasoning in domains such as coding and mathematics. In this example, RLVR methods are applied towards forecasting future real-world events—a challenging task for RL due to the very noisy (and delayed) outcomes involved. Using a novel dataset of recent questions from a prediction market, and accompanying relevant news headlines, experimental results show that a compact (14B) reasoning model can be trained to match or surpass the predictive accuracy of frontier models such as OpenAI's o1, while greatly improving probabilistic calibration.

RLVR methods are principally applied to problems whose outcomes are deterministic and instantly verifiable. However, using the techniques described herein, RLVR methods can be applied to the problem of forecasting world events. This presents a substantial challenge, due to the inherently noisy and delayed outcomes involved: forecasting requires causal inference, trend extrapolation, and well-calibrated probabilities while supplying only sparse, lagged supervision. Under these conditions, standard GRPO-style updates can drive policies toward extreme overconfidence, gibberish output, or outright training collapse. Adapting RLVR to this setting promises to extend model reasoning ability to an especially demanding domain, potentially unlocking a host of real-world applications.

In this example, the design and empirical validation of a stable RL pipeline for probabilistic forecasting are described. In some examples, on the algorithmic side, (i) per-question standard-deviation scaling is removed from Group Relative Policy Optimization (GRPO), (ii) baseline-subtracted advantages are used in ReMax, and/or (iii) lightweight guard-rails, token-length limits, a gibberish filter, and an early stop criterion are added, to keep gradients proportional to Brier loss and prevent collapse over more than 100,000 sequential events.

On the evaluation side, a novel dataset of 1,265 questions on Polymarket is used, with accompanying news headlines up to a given prediction date, taking several measures to avoid temporal leakage (a common issue when back testing the accuracy of forecasting models). Accuracy is assessed with the soft-Brier score and calibration with expected calibration error (ECE). Economic value is quantified by converting each forecast into a set of hypothetical trades and comparing realized profits with those of the frontier reasoning model o1 as a benchmark.

Overall, on the 1,265-question hold-out set, a seven-run ReMax ensemble attains a Brier of 0.190 [0.178, 0.203] and an ECE of 0.062, meaning it achieves the same accuracy as o1 while drastically improving calibration. In a simulated trading scenario, in which the model places a one-share hypothetical bet on every Polymarket question in the test set, the ReMax ensemble earns a profit of $52 versus $39 for o1. Thus, the ReMax ensemble is able to outperform frontier reasoning models in both accuracy and calibration when forecasting future world events, and can leverage this capability to earn meaningful profit in real-money prediction markets.

Data and pre-processing. An ordered training dataset of 10,000 training questions were collected from Polymarket (yes/no contracts), including creation date, close date, resolution timestamp and final outcome. For each question, a single prediction date was drawn uniformly at random between its on-chain open and scheduled close. For each question, the Exa.ai API was used to retrieve news headlines from before the sampled prediction date (Exa.ai offers day-level granularity) to include in a model's prompt. This approach aims to ensure that the model never sees information in its prompt dated on or after its own forecast.

When developing and evaluating forecasting models, it is important to avoid sources of ‘temporal leakage,’ in which the model is able to use knowledge of future events implicit in its training data or prompt to gain an unfair advantage. To construct the test set, the same approach used in the construction of the training dataset is followed, but additional steps are taken to minimize the possibility of temporal leakage. For example: 1. The test set is constructed such that all questions' prediction-dates occur after the latest resolution date of any training question. 2. Many questions have indeterminate resolution dates (e.g., “Will X happen sometime before Y?′), which could reveal information about the future due to selecting on only resolved questions. To address this possibility, test-set questions are restricted to those which were originally scheduled to close by the time of dataset construction. 3. The Exa.ai API could potentially include errors in the date a given news article was published, allowing future information to leak into the prompt. To address this possibility, a distinct model (e.g., OpenAI 03) is used to flag any questions for which the news stories contain relevant information that should not have been known at the prediction date, and these questions are excluded from the test set.

In addition, all questions with zero trading volume were excluded from the test set, to allow fair comparison with Polymarket forecaster predictions.

For a second set of experiments, 100,000 additional training questions and answers were generated using the foresight-based data generation framework described herein. These additional questions and answers are sometimes referred to herein as the “Lightning-100 k” training set. These questions follow a similar format but are created automatically without humans in the loop or labeled data. In the second set of experiments, the same initial 10,000 questions are used with the additional 100,000 synthetic questions mixed in and time-ordered. The same held-out test set of 1,265 questions is reserved for all models.

Model. All experiments are conducted with DeepSeek-R1-Distill-Qwen-14B, a 14-billion-parameter model initialized from the open-weight Qwen 2.5-14B base checkpoint and further instruction-tuned on the 800 k-sample DeepSeek-R1 distilled reasoning corpus. The fine-tuning experiments described herein take this model as the base model, and results are compared to this base model as well as other benchmarks and frontier models.

RL Algorithms and Updates. Three on-policy RL algorithms are evaluated, GRPO, Modified-GRPO, and ReMax, and Direct Preference Optimization (DPO) is evaluated as an off-policy baseline.

For the Group Relative Policy Optimization (GRPO) policy, for each question q G outputs {o¹, . . . , o^{G}} are drawn from the old policy π_{θold} (·|q) and each output oⁱ is assigned a scalar reward rⁱ. The advantage function is Âⁱ=(rⁱ−μ)/σ, where u is the mean reward of the group and σ is the standard deviation of the group. Normalizing by σ stabilizes the updates, but can dampen the learning signal when particularly large rewards are important.

For the Modified-GRPO algorithm, the standard GRPO algorithm is modified by removing the division by the standard deviation and setting Âⁱ=rⁱ−μ. This modification preserves the raw magnitude of especially large forecast errors, potentially improving the model's ability to correct extreme miscalibrations. Yet, omitting the normalization can make optimization more sensitive to outliers, which can be addressed using additional guard-rails to mitigate instability.

For the ReMax policy, G outputs {o¹, . . . , o^{G}} from the old policy π_{θold} (·|q) are sampled, each with reward rⁱ. Let bⁱ be a learned baseline for each oⁱ. The advantage is set to Âⁱ=rⁱ−bⁱ, removing the need to divide by a standard deviation. Subtracting a baseline in lieu of variance normalization often better preserves large reward signals.

In the experimental forecasting context, normalizing each question's rewards by their standard deviation (as in standard GRPO) can excessively dampen large errors and encourage overconfidence: per-question normalization flattens the reward distribution and erases the natural asymmetry whereby modest gains accrue from correct but overconfident predictions, while rare mis-predictions incur disproportionately large penalties, the very signal the model needs to learn proper calibration. Removing per-question normalization (Modified GRPO) or using ReMax's baseline-based approach, better preserves the impact of large deviations, improving calibration when probabilistic forecasts deviate significantly from eventual outcomes.

Online, single-pass training. All on-policy algorithms (GRPO, Modified-GRPO, ReMax) are trained strictly online: each question is encountered only once in chronological order, and its outcome is revealed immediately after the event date. We do not perform multiple epochs, as re-exposing the model to past questions after outcomes are known leads to severe over-fitting (the model essentially “learns the future” on subsequent epochs).

Guard-rails. Scaling the training to 100 k questions introduces stability challenges, particularly related to overconfidence, where some models drift toward 0% or 100% forecasts when per-question reward normalization is used, and the generation of invalid text or gibberish, where large, noisy datasets can push the policy to produce nonsensical or non-English text. This happens especially when reward gradients fail to distinguish valid forecasts from invalid ones. To maintain stable training at scale, a scorer can deduct a reward whenever a response violates any of three checks: (1) the response includes out-of-context non-English passages, (2) the response includes nonsense or random character strings, and/or (3) the response lacks an explanation for the final answer inside a <think> . . . </think> block.

Baselines. The four RL algorithms are compared and benchmarked against two additional references: 1. OpenAI's o1, prompted with the same question text, to assess performance against a frontier reasoning model. 2. Market prices (Polymarket), the market's implicit probability at the time each question was asked. For every test question, the Polymarket price is sampled at precisely the same timestamp used for the prompt cut-off, yielding a strictly contemporaneous benchmark. These baselines indicate how our RL-trained models perform relative to both a state-of-the-art commercial LLM and a real-world prediction market.

Results. Predictive accuracy is measured with the soft-Brier score, defined as the squared error (\hat{p}-y)² averaged over all 1,265 questions but assigning a soft penalty of 0.25 whenever a model fails to produce a parseable probability. A score of 0.25 is equivalent to guessing 50% on a question, and thus functions as a suitable stand-in for failed responses. For calibration, the expected calibration error (ECE) computed in ten equal-mass probability bins is used. For both accuracy and calibration, lower scores indicate higher accuracy and better calibration, respectively. All statistics are paired across the identical question set; confidence intervals (CI) are two-sided 95% Wald intervals for Brier and bootstrap intervals for ECE unless specified otherwise; every p-value reported below is two-sided.

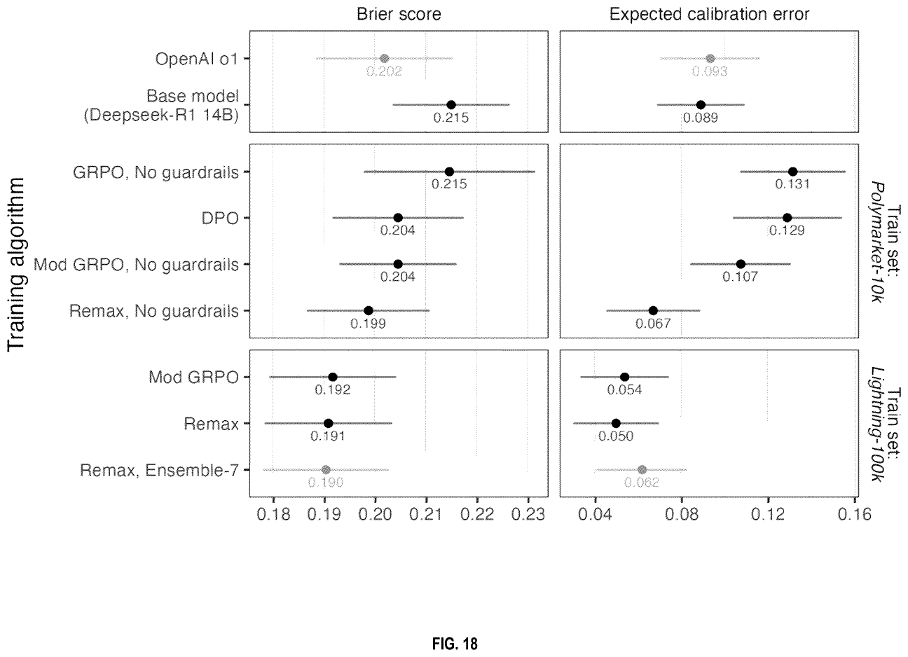

FIG. 18 shows calibration results for the experimental models and the benchmark models, including mean soft-Brier score (accuracy, left) and mean expected calibration error (ECE, right) for each training algorithm evaluated on the Polymarket hold-out set. Error bars show 95% confidence intervals. Lower values are better on both axes. These results indicate that the differences in calibration arising from the different training algorithms are reduced when the training set is large (e.g., when the Lightning-100 k training set produced using foresight-based data generation is used).

As shown in FIG. 18, among the 10 k-trained models, the model optimized using ReMax was most accurate, with a soft-Brier score of 0.199 [0.187, 0.211]. This model also achieved the best probabilistic calibration, with an expected calibration error of 0.067 [0.047, 0.087]. In the follow-up experiment, scaling ReMax to the 100 k-Lightning corpus and ensembling the predictions across 7 samples achieved a Brier score of 0.190 [0.178, 0.203] and an ECE of 0.062 [0.041, 0.082].

Table 1 reports mean soft-Brier score and ECE for the 7-run ReMax ensemble and Modified-GRPO (both trained on the Lightning-100 k corpus), compared to both frontier and human baselines. While no models achieved the same accuracy as human forecasters on Polymarket, the most effective finetuned model (Remax, Ensemble-7) was nonetheless significantly more accurate than OpenAI o1, despite being likely 1-2 orders of magnitude smaller in parameter count. In Table 1, Soft-Brier and ECE are means across questions; lower is better. Differences are (model-reference). Stars mark two-sided p-values for the corresponding pair-wise tests (*<0.05, **<0.01, * **<0.001).

TABLE 1
Accuracy summary and pair-wise tests (1,265 questions).

| | Descriptive | | | | |
|---|---|---|---|---|---|
| | Means | | | | |
| | Soft- | | Brier difference (Δ vs.) | | |
| Model | Brier | ECE | Base | o1 | Market |
| DeepSeek-R1 14B | 0.215 | 0.089 | — | +0.013** | +0.064*** |
| ReMax, Ensemble-7 | 0.190 | 0.062 | −0.025*** | −0.011* | +0.039*** |
| Modified-GRPO | 0.192 | 0.054 | −0.023*** | −0.010 | +0.041*** |
| OpenAI o1 | 0.202 | 0.093 | −0.013** | — | +0.051*** |
| Polymarket | 0.151 | 0.043 | −0.064*** | −0.051*** | — |

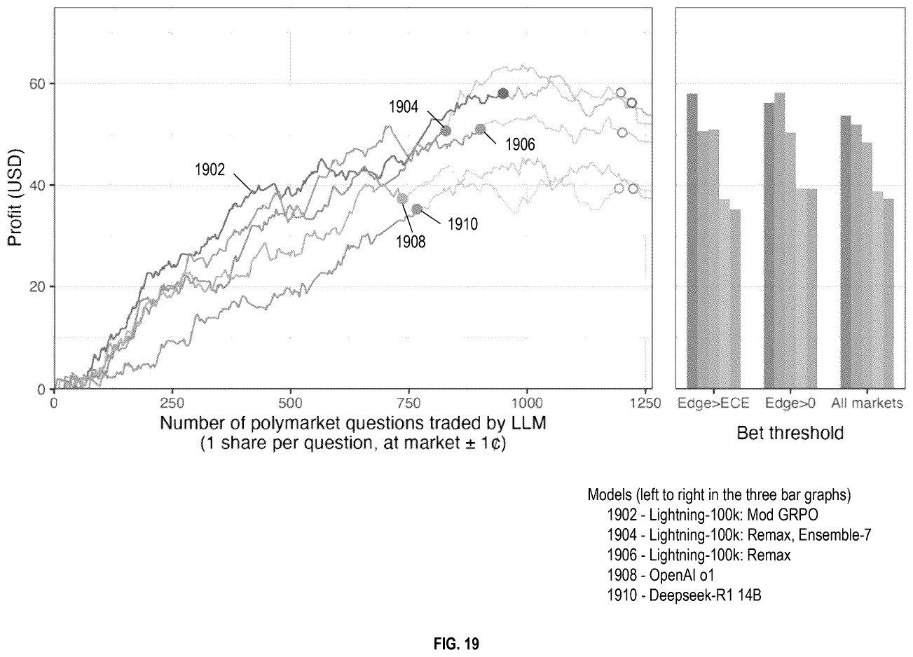

Hypothetical Trading Evaluation. While no model was alone able to achieve a lower Brier score than Polymarket itself, a model's predictions may nonetheless contain incremental information beyond what is captured by the market price. To provide another test of each model's value in aiding human prediction, a simulation analysis was conducted in which each model was used to place hypothetical one-share ‘bets’ on all questions in the test set. The profit or loss that these bets would have returned on Polymarket was then calculated. For this simulation, every probability was first converted into a one-share trade against the contemporaneous Polymarket price. For each resolved contract with non-zero volume, the model's probability p is compared with the last quoted market price m. If p>m the strategy buys one $1 long share at m+0.01; if p <m it shorts one share at (1−m)+0.01; exact ties are broken at random. The added cent approximates fees and slippage. Each trade therefore has a known entry cost c, an expected value under the model's belief (p for longs, 1-p for shorts), and a realized value v∈{0, 1} at resolution. Five models are evaluated: Foresight Learning with ReMax (1906), Foresight Learning with ReMax Ensemble-7 (1904), Foresight Learning with Modified GRPO (1902), the untuned DeepSeek-R1 base model (1910), and the frontier benchmark OpenAI o1 (1908). Referring to FIG. 19, profits v-c are aggregated in descending order of expected edge to yield cumulative-profit curves, and we the total return is reported under three bet-selection rules: trading until the edge drops below (i) the model's own expected calibration error (Edge>ECE), (ii) zero after fees (Edge >0), and (iii) across all markets.

In FIG. 19, the line graph on the left shows cumulative realized profit (USD) as each model sequentially places one-share trades, ranked by ex-ante expected edge. Solid disks mark the last trade with Edge>ECE; open rings mark the last trade with Edge>0. Right: total profit under the three bet-selection rules. Truncating the strategy at the calibration threshold (Edge>ECE) retains almost the entire upside while avoiding the loss-making tail.

FIG. 19 visualizes the return on trading for each model tested. The left panel shows cumulative realized profit through the 1,265 Polymarket questions in descending order of expected edge; the right panel condenses the final take under the three bet-selection rules. Overall, all models were able to earn a total (hypothetical) profit when betting on Polymarket questions in the simulation. This result held even in the most challenging case-forcing a model to bet on every market even when it expects to make a loss (when it agrees with the market price to within 1c). However, by far the largest profit was achieved by the two finetuned models, trained by ReMax (profit $52, from a total cost of $433) or Modified GRPO (profit $54, cost $428). This corresponds to a total return of investment of approximately 10% across all questions.

These results indicate that the accuracy of our forecasting approach is sufficient to be practically meaningful, providing substantial information to inform future prediction beyond what is available in prediction markets. In addition, for test set questions on which Polymarket was highly confident, the best-performing model was not statistically better than chance at betting against the market. Rather, its overall profit was driven almost entirely by questions on which the market was most unsure (market probability 40-60%). For these questions, the model's bets were successful 11.8 percentage points [8.0, 15.7] more often than would be predicted by the market price. In terms of trading profit, this corresponds to a substantial return on investment of approximately 20% on these questions.

This example demonstrates the effective application of Reinforcement Learning with Verifiable Rewards (RLVR) to the challenging domain of forecasting real-world events. A variety of reasoning models were trained, that take as input a TRUE/FALSE forecasting question, alongside a set of news articles published before the prediction date, and aim to predict how the question will resolve. A variety of training algorithms were compared for reasoning models, using a sample of 100 k historical questions (10 k real+90 k synthetic). On a test set of recent forecasting questions, the best-performing model was a 7-run ensemble trained using ReMax, and with guardrails to improve learning stability. This model reached a Brier score of 0.190: significantly 0outperforming much larger frontier models. These gains are also practically meaningful: in a trading simulation, the ReMax ensemble earned a total of $52 in profit from simulated bets on Polymarket, with a 10% return on investment—or 20% among questions with low market confidence. These results highlight the promise of well-calibrated RL-trained forecasters to serve as tools to support human reasoning under uncertainty.

### Example 6. Scalable Supervision from Foresight-Based Data Generation

Introduction. Reinforcement learning with verifiable rewards (RLVR) has emerged as an effective approach for improving language models in domains such as mathematics, code generation, and formal reasoning, where correctness can be checked automatically. By replacing human annotation with deterministic reward functions, these methods scale efficiently and yield strong empirical gains. However, their applicability depends on the availability of immediate, closed-form verification, restricting them to tasks where correctness can be resolved at training time. As a result, despite their success, existing RLVR approaches remain confined to a narrow class of problems defined by readily available, task-specific reward signals.

In contrast, many real-world processes evolve over time and resolve to objective outcomes that are independent of the model. These outcomes, such as the conclusion of an election or the decision in a court case, are publicly observable and verifiable after the fact. This temporal structure induces a natural asymmetry between the information available at prediction time and the information revealed at resolution, creating a setting in which predictions can be evaluated retrospectively without relying on contemporaneous labels. In this example, this temporal structure is translated into a scalable learning framework for generative models (e.g., language models). Learning from real-world temporal streams is formalized by grounding supervision in event resolution. A causal constraint is exploited: at prediction time t, the model is restricted to information available up to t, while evaluation is deferred until the corresponding outcome is realized. This formulation extends reinforcement learning with verifiable rewards beyond closed-world tasks with immediate feedback to settings where correctness is determined only after external, real-world resolution.

Adopting a reward-based objective frames prediction as a stochastic decision evaluated retrospectively after outcome resolution. In contrast to supervised fine-tuning, which fits fixed targets, foresight learning optimizes over sampled reasoning trajectories using only outcome-based rewards, without intermediate annotations or task-specific labels. This perspective emphasizes calibration and decision quality rather than target matching. While this example focuses on binary outcomes for clarity, the formulation generalizes to richer outcome spaces, such as continuous, multi-class, and free-text outcomes.

This example, formalizes learning from temporally resolved real-world events as an extension of reinforcement learning with verifiable rewards, introduces an annotation free algorithm for learning from delayed, outcome-based supervision, and shows that this approach yields substantial improvements in calibration and predictive accuracy over strong pretrained baselines.

Example Process. In this example, supervision is provided by the eventual resolution of events rather than contemporaneous labels. At prediction time t, the model observes only information available up to that cutoff and predicts whether an event will occur by a later time s> t. Although training is performed on events whose outcomes are already known, inputs are causally filtered to exclude post-t information, and rewards may be computed solely from outcome resolution at time s, preserving the temporal asymmetry of prediction by construction.

Learning formulation. Each episode corresponds to a single future-event prediction.

Predictor and resolver roles. Foresight learning decomposes learning from temporal streams into two roles with asymmetric information access: (1) The predictor is the generative model being trained. At time t, it observes a temporally masked information state and produces a probabilistic prediction about a future event. (2) The resolver is an external, fixed process that determines the realized outcome once the event resolves at time s>t. The resolver may be implemented using a pretrained, frozen language model that is not trained, updated or influenced by the learning process. The resolver has access to post-t information unavailable to the predictor and may be used solely to resolve outcomes, not score or rank predictions.

The predictor and resolver can be strictly separated, such that the predictor never observes resolution information, and the resolver does not observe model outputs or training dynamics. Learning is driven by the information gap between the predictor's masked view at time t and the resolver's unmasked view at time s.

State. The state consists of all information available up to time t, including relevant dated text and a natural-language specification of an event guaranteed to resolve by time s>t. The predictor operates under a masked information state, with all post-t information causally excluded by construction.

Action. Conditioned on the state, the policy samples an internal reasoning trajectory terminates in a probabilistic prediction p∈(0, 1), represented as a scalar value rather than a generated token. Only this numeric probability is exposed to the environment. Formally, the action is the emitted probability; the trajectory is an internal stochastic computation optimized via policy gradients.

Reward. Once the event resolves, a terminal reward is assigned using the log score: e.g., Reward=y·log(p)+(1−y)·log(1−p), where y∈{0, 1} is the realized outcome. This strictly proper scoring rule incentivizes calibrated probabilistic predictions and provides a continuous learning signal under uncertainty.

Outcome determination is performed by a separate resolver that observes the unmasked future. The resolver has access to post-t sources unavailable to the predictor and is used solely to verify whether the event occurred. Each episode terminates after outcome resolution; there are no intermediate rewards.

Although the terminal reward takes the form of a proper scoring rule, this learning setup is not simply supervised likelihood training. In expectation, optimizing this reward corresponds to maximizing the log-likelihood of realized outcomes conditioned on the information available at prediction time. However, the learning problem is structured differently: the predictor acts under a causally masked information state without access to outcomes, and training optimizes a stochastic policy over reasoning trajectories whose quality is evaluated only after outcome resolution. Credit assignment can be performed via policy gradients on sampled trajectories rather than by directly differentiating a likelihood objective, preserving the decision-theoretic structure of acting under asymmetric information.

This formulation treats prediction as a stochastic decision evaluated retrospectively after outcome resolution, distinguishing it from supervised likelihood training even though the reward takes the form of a proper scoring rule.

Objective and optimization. In some examples, the objective is to maximize expected terminal reward under outcome-based supervision. In this regime, single-sample policy gradients exhibit high variance due to sparse terminal feedback and intrinsic uncertainty in event outcomes. To address this, the policy can be optimized using Group Relative Policy Optimization (GRPO).

With GRPO, for each state, the policy samples a group of K trajectories, each producing a probabilistic prediction. After outcome resolution, a reward is computed for each trajectory. A group-relative advantage is defined by subtracting the mean reward within the group:

$$Advantage ( {τ}_{i} ) = Reward ( {τ}_{i} ) - ( \sum Reward ( {τ}_{j} ) ) / K .$$

In some examples, policy updates maximize the expected advantage-weighted log probability of each trajectory under the current policy. By comparing trajectories generated under identical pre-t information, GRPO reduces variance from outcome noise and stabilizes learning when supervision is provided only through terminal outcomes. Gradients can be applied to all tokens in each trajectory, enabling credit assignment across extended reasoning processes even though feedback is available only at the final step.

Training protocol. In some examples, a causal information constraint is enforced by applying a temporal information mask to the input stream. For each prediction time t, the predictor may be restricted to observing only information timestamped at or before t, even though training is performed offline. All training events resolve strictly after the pretrained model's knowledge cutoff, ensuring that realized outcomes cannot be encoded in the model's parametric memory. All post-t information-including sources required to determine the outcome—is withheld during prediction and policy optimization. Outcome verification is performed by a separate resolver with access to the unmasked stream. This preserves a strict causal separation between observation, action, and verification throughout training.

### Experimental Setup.

Dataset construction. A future-event prediction dataset is constructed. The dataset is designed to preserve a strict temporal separation between prediction and verification. The pre-cutoff information state consists of an English-language news corpus aggregated from publicly accessible outlets (e.g., international newspapers, wire services, and financial news sites). Articles are timestamped using publisher-provided publication times, normalized to UTC.

For each example, we freeze the news corpus at a cutoff time t and generate a binary question about an event expected to resolve strictly after that cutoff, using only information available prior to t. The cutoff is defined with respect to publisher-reported publication timestamps; articles with missing or ambiguous timestamps are excluded to prevent temporal leakage. Generated events span multiple domains, including politics, economics, and corporate actions.

To prevent information leakage, model inputs are constructed exclusively from sources published at or before time t. Outcome verification uses independent post-t sources that are not included in the model's input context. Event outcomes are resolved automatically by a separate, frozen large language model (Gemini-2.5-Flash) with access to a broader pool of post-cutoff news and archival sources, and used solely to determine whether an event occurred. The resolver does not observe model outputs or training dynamics; as a result, resolution errors introduce noise but do not induce endogenous reward signals. Examples that cannot be resolved with high confidence are discarded. Each event is assigned a resolution time s, defined as the earliest dated source supporting the resolved outcome.

In some examples, all questions and outcomes are generated prior to training, enabling fully offline optimization while preserving the temporal and causal structure of real-world prediction.

Models and training. A Qwen3-32B language model with explicit reasoning enabled is fine-tuned. Conditioned on an information state, the model generates a reasoning trajectory that terminates in a probabilistic prediction expressed explicitly at the end of the output. Parsed probabilities may be constrained to the interval [0.001, 0.999] for numerical stability.

Training is performed using GRPO. For each event, the model samples four independent trajectories, each producing a probabilistic prediction. After outcome resolution, a log-score reward is computed for each trajectory, and relative advantages are obtained by subtracting the per-group mean reward. Policy updates increase the relative likelihood of higher-reward trajectories. Training uses batches of 32 events, with prediction horizons mixed within each batch.

Baselines. Foresight learning is compared to baselines that operate under identical temporal constraints and produce probabilistic predictions in the same output format, isolating the effect of learning. These baselines are referred to herein as “prompted forecasting” and “ensembling.” With prompted forecasting, the base Qwen3-32B and Qwen-235B models are prompted to produce probabilistic predictions without task-specific fine-tuning. This baseline measures forecasting performance without learning from outcome resolution. With ensembling, multiple independent predictions are generated per event and averaged to assess gains from sampling and aggregation without parameter updates. This control tests whether improvements can be explained by variance reduction alone.

Evaluation Metrics. Models are evaluated based on the quality of probabilistic predictions. We report the log score used for training, the Brier score, which measures squared error between predicted probabilities and outcomes, and calibration, assessed via expected calibration error (ECE) over 10 discretized probability bins measuring empirical outcome frequencies as a function of predicted confidence.

Results. Models trained with foresight learning are evaluated on two held-out test sets: (i) a synthetic future-event benchmark of 500 questions constructed under strict temporal controls, and (ii) an external benchmark consisting of 293 binary forecasting questions from Metaculus. Performance is evaluated using proper scoring rules and calibration metrics.

Table 2 compares four inference regimes: (i) Qwen3-32B prompted for a single forecast, (ii) Qwen3-32B prompted for seven independent forecasts with the median taken as the final prediction, (iii) Qwen3-235B prompted for a single forecast, and (iv) the Foresight-trained model prompted once. Repeated prompting and median aggregation provide modest improvements over single-sample prompting but do not match the gains from training on resolved outcomes. Notably, the Foresight-trained 32B model outperforms both the ensemble-style baseline and the substantially larger 235B model across all metrics, indicating that the improvements stem from the training objective rather than increased sampling or model scale.

TABLE 2
Forecasting performance on synthetic and real-world benchmarks.

| | | | |
|---|---|---|---|
| Model | Log ↑ | Brier ↓ | ECE ↓ |

Metaculus

| | | | |
|---|---|---|---|
| Qwen3-32B | −0.7210 | 0.2472 | 0.2175 |
| Qwen3-32B Ensemble | −0.7000 | 0.2390 | 0.2289 |
| Qwen3-32B-RL (160) | −0.5738 | 0.1793 | 0.1042 |
| Qwen3-235B | −0.6828 | 0.2111 | 0.1905 |

Synthetic future-events

| | | | |
|---|---|---|---|
| Qwen3-32B | −0.7166 | 0.2432 | 0.1732 |
| Qwen3-32B Ensemble | −0.7045 | 0.2481 | 0.1864 |
| Qwen3-32B-RL (160) | −0.5978 | 0.1979 | 0.0598 |
| Qwen3-235B | −0.7138 | 0.2260 | 0.1695 |

Performance gains persist on the Metaculus benchmark, which consists of independently authored questions outside the synthetic benchmark distribution. One possible contributing factor is that Metaculus questions often concern higher-salience events with broader public coverage, providing richer information at prediction time. While this hypothesis requires further study, the results indicate that learning from externally resolved outcomes generalizes beyond the specific data construction process used for training.

Taken together, these results support a premise of foresight learning: incorporating outcome resolution directly into the training objective yields more accurate and better-calibrated probabilistic forecasts than prompting or sampling-based baselines alone, even when compared to substantially larger pretrained models.

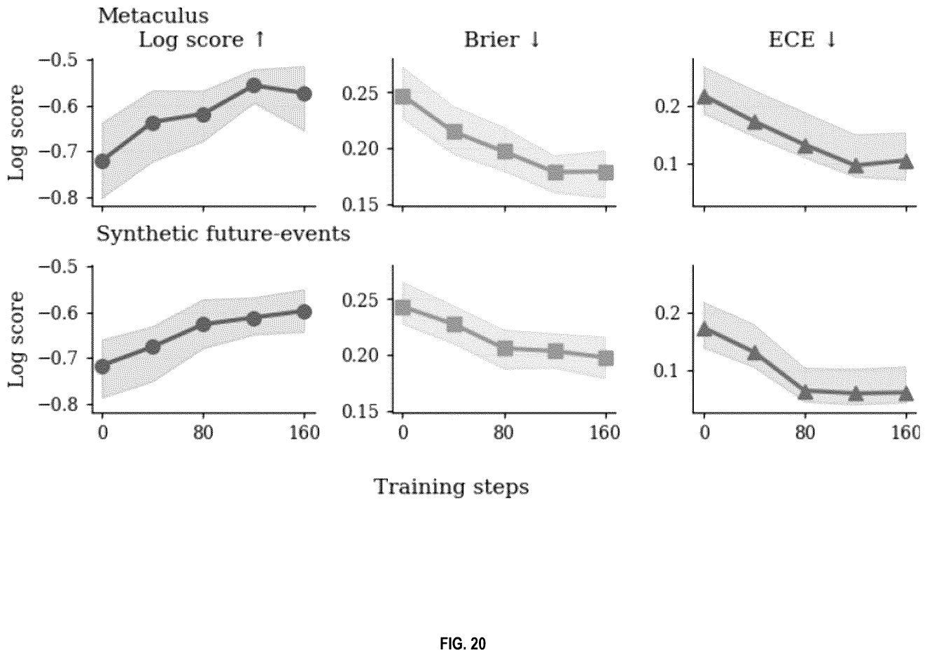

FIG. 20 shows model calibration and accuracy metrics versus training steps on Metaculus (top) and synthetic future-events (bottom). Shaded regions show 95% bootstrap confidence intervals. Metrics are log score (1), Brier score (1), and expected calibration error (ECE; 1). In the results shown in FIG. 20, performance of the model trained with foresight learning generally improves monotonically with training.

Discussion. This example presents a supervision regime in which feedback is provided by the eventual resolution of real-world events rather than contemporaneous labels or proxy objectives. By optimizing probabilistic predictions retrospectively using proper scoring rules, foresight learning aligns training with the temporal and causal structure of forecasting under uncertainty. Empirically, learning from outcome resolution improves probabilistic forecasting performance relative to a strong pretrained baseline, with consistent gains in accuracy and calibration on both synthetic future-event datasets and the independently authored Metaculus benchmark. Notably, foresight learning materially outperforms a substantially larger same-generation model on real-world forecasting tasks.

One benefit of outcome-based supervision is improved calibration. Because rewards are assigned only after outcomes resolve, overconfident incorrect predictions incur large penalties, while appropriately uncertain predictions are penalized less severely. This learning signal encourages inference strategies that balance evidence aggregation with uncertainty estimation, whereas sampling-based heuristics such as ensembling reduce variance without modifying the underlying prediction policy.

Relative to reinforcement learning with verifiable rewards, foresight learning operates in open-world domains with sparse and delayed feedback. Trajectory-level, group-relative optimization enables stable credit assignment under long and variable horizons by comparing alternative predictions generated under identical informational constraints and evaluating them retrospectively after outcomes resolve.

Overall, this example demonstrates that, with foresight learning techniques, effective supervision can arise directly from chronologically evolving real-world data. By incorporating outcome resolution into the training objective, the framework points toward a broader role for outcome-based supervision in extending verifiable reward-driven learning beyond closed-world tasks and toward open-ended, real-world decision-making.

### Further Examples

B. Turtel, et al. Foresight learning for SEC risk prediction. Jan. 27, 2026, available at https://arxiv.org/abs/2601.19189, describes the use of foresight-based data generation and foresight learning techniques to train models on SEC filings). The foregoing publication is hereby incorporated by reference herein.

### Computer-Based Implementations

Techniques operating according to the principles described herein may be implemented in any suitable manner. Included in this disclosure are one or more flow charts showing the steps and acts of various processes for training generative models using foresight learning. The processing and decision blocks of the flow charts represent steps and acts that may be included in algorithms that carry out these various processes. Algorithms derived from these processes may be implemented as software integrated with and directing the operation of one or more single- or multi-purpose processors (e.g., central processing units (CPUs), graphics processing units (GPUs), tensor processing units (TPUs), etc.), may be implemented as functionally-equivalent circuits such as a Digital Signal Processing (DSP) circuit, Field Programmable Gate Array (FPGA), or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one of ordinary skill in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of software. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities are described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media of a computing device 2100) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, or one or more computing devices (or one or more processors of one or more computing devices) may be programmed to execute the computer-executable instructions. A computing device or processor may be programmed to execute instructions when the instructions are stored in a manner accessible to the computing device/processor, such as in a local memory (e.g., an on-chip cache or instruction register, a computer-readable storage medium accessible via a bus, a computer-readable storage medium accessible via one or more networks and accessible by the device/processor, etc.). Functional facilities that comprise these computer-executable instructions may be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

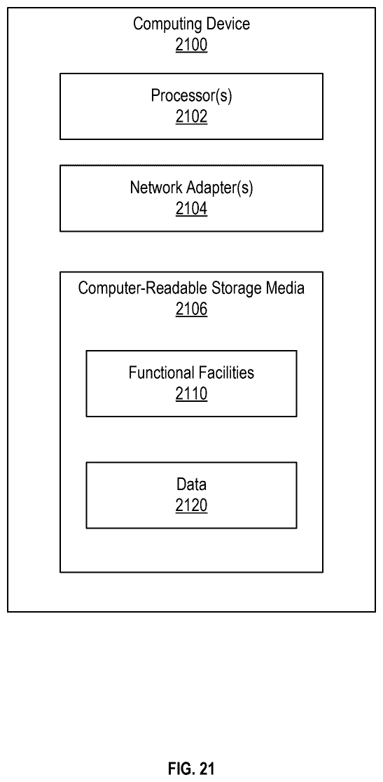

FIG. 21 illustrates one exemplary implementation of a computing device 2100 that may be used in a system implementing the techniques described herein, although others are possible. It should be appreciated that FIG. 21 is intended neither to be a depiction of necessary components for a computing device to operate in accordance with the principles described herein, nor a comprehensive depiction.

Computing device 2100 may comprise at least one processor 2102, a network adapter 2104, and computer-readable storage media 2106. Computing device 2100 may be, for example, a desktop or laptop personal computer, a personal digital assistant (PDA), a smart mobile phone, a server, or any other suitable computing device. Network adapter 2104 may be any suitable hardware and/or software to enable the computing device 2100 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 2106 may be adapted to store data to be processed and/or instructions to be executed by one or more processors 2102. Processor 2102 enables processing of data and execution of instructions. The data and instructions may be stored on the computer-readable storage media 2106.

The data and instructions stored on computer-readable storage media 2106 may comprise computer-executable instructions implementing techniques which operate according to the principles described herein. In the example of FIG. 21, computer-readable storage media 2106 stores computer-executable instructions implementing various facilities and storing various information as described herein. Computer-readable storage media 2106 may store one or more functional facilities 2110 (e.g., task generator 110, generative model 120, resolver 130, and/or trainer 150) and/or data 2120 (e.g., training data 140 or dynamic data source 160). The functional facilities stored on the computer-readable storage media may be suitable for implementing any of the systems described herein (e.g., system 100) and/or for performing any of the methods describe herein (e.g., methods 200, 300, 400, and/or 500).

While not illustrated in FIG. 21, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination. For example, aspects described in one embodiment may be combined in any manner with aspects described in other embodiments.

### Terminology

The terminology used herein is for the purpose of description and should not be regarded as limiting.

Measurements, sizes, amounts, etc. may be presented herein in a range format. The description in range format is merely for convenience and brevity and should not be construed as an inflexible limitation on the scope of some embodiments. Accordingly, the description of a range should be considered to have specifically disclosed all the possible subranges as well as individual numerical values within that range. For example, description of a range such as 10-20 inches should be considered to have specifically disclosed subranges such as 10-11 inches, 10-12 inches, 10-13 inches, 10-14 inches, 11-12 inches, 11-13 inches, etc.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A reinforcement learning method, comprising performing, by a processor, operations including:
providing, as input to a first model, input data representing a task related to an outcome of an event, wherein the outcome of the event is unresolved at a first time;
obtaining synthetic data provided by the first model based on the input data, the synthetic data indicating one or more predictions regarding the outcome of the event, wherein an information state observed by the first model is limited to data available prior to the first time;
obtaining resolution data provided by a second model based on the input data, the resolution data indicating a determination regarding the outcome of the event, wherein the outcome of the event is resolved by a second time later than the first time, and wherein an information state observed by the second model includes data available after the second time;
determining, based on the one or more predictions regarding the outcome and the determination regarding the outcome, one or more rewards corresponding, respectively, to the one or more predictions; and
training the first model based on the one or more rewards.

2. The method of claim 1, wherein the synthetic data are provided by the first model prior to the first time, and the resolution data are provided by the second model after the second time.

3. The method of claim 1, wherein the resolution data are provided by the second model before the input data are provided as input to the first model, and wherein the information state observed by the first model is temporally masked.

4. The method of claim 1, wherein the first model comprises a predictive model.

5. The method of claim 4, wherein each of the one or more predictions regarding the outcome of the event comprises a binary label characterizing the outcome of the event, a multi-class label characterizing the outcome of the event, multi-label data characterizing the outcome of the event, or a number characterizing the outcome of the event.

6. The method of claim 1, wherein the first model comprises a generative model.

7. The method of claim 6, wherein each of the one or more predictions regarding the outcome of the event comprises a binary label characterizing the outcome of the event, a multi-class label characterizing the outcome of the event, multi-label data characterizing the outcome of the event, a number characterizing the outcome of the event.

8. The method of claim 7, wherein each of the one or more predictions regarding the outcome of the event comprises text data, image data, audio data, or video data characterizing the outcome of the event.

9. The method of claim 1, wherein each of the one or more predictions regarding the outcome of the event includes a probability value indicating a probability of the event occurring.

10. The method of claim 9, wherein the determination regarding the outcome of the event includes an occurrence value indicating whether the event occurred.

11. The method of claim 10, wherein the occurrence value indicates that the event occurred, and for each prediction of the one or more predictions, the reward corresponding to the respective prediction is based on a logarithm of the probability value of the respective prediction.

12. The method of claim 10, wherein the value indicates that the event did not occur, and for each prediction of the one or more predictions, the reward corresponding to the respective prediction is based on a logarithm of a complement of the probability value of the respective prediction.

13. The method of claim 1, wherein each of the one or more predictions regarding the outcome of the event includes prediction data characterizing the outcome of the event and a probability value indicating a probability that the prediction data are correct.

14. The method of claim 13, wherein the determination regarding the outcome of the event includes determination data characterizing the outcome of the event.

15. The method of claim 14, wherein determining the one or more rewards corresponding to the one or more predictions comprises, for each prediction and each corresponding reward:
determining a correctness value indicating a correctness of the respective prediction based on the prediction data of the respective prediction and the determination data;
determining a first reward term based on the correctness value and a logarithm of the probability value of the respective prediction;
determining a second reward term based on a complement of the correctness value and a logarithm of a complement of the probability value of the respective prediction; and
combining the first reward term and the second reward term.

16. The method of claim 15, wherein determining the correctness value comprises assessing a similarity of the prediction data of the respective prediction to the determination data.

17. The method of claim 1, wherein training the first model based on the one or more rewards comprises updating a policy of the first model based on a reinforcement learning algorithm and the one or more rewards.

18. The method of claim 17, wherein the reinforcement learning algorithm is a group relative policy optimization (GRPO) algorithm, a modified GRPO algorithm, a ReMax algorithm, or a Direct Preference Optimization (DPO) algorithm.

19. The method of claim 1, wherein the information state observed by the first model includes data used to train or fine-tune the first model and/or context data accessed by the first model.

20. The method of claim 1, wherein each of the one or more rewards comprises a value based on an accuracy of a prediction of the first model.

21. A reinforcement learning system, comprising:
a processor;
a computer-readable storage medium storing instructions which, when executed by the processor, cause the system to perform operations including:
obtaining training data including input data and resolution data, wherein the input data represent a task related to an outcome of a real-world event, wherein the outcome is unresolved as of a first real-world time and resolved as of a second real-world time later than the first real-world time, wherein the resolution data are provided by a second model based on the input data, the resolution data indicating a determination regarding the outcome of the real-world event, and wherein an information state of the second model includes data available after the second real-world time;
temporally masking an information state of a first model, such that the information state observed by the first model is limited to data available prior to the first time;
providing the input data as input to the first model;
obtaining synthetic data provided by the first model based on the input data, wherein the synthetic data indicate one or more predictions regarding the outcome of the real-world event, and wherein the information state observed by the first model is temporally masked;
determining, based on the one or more predictions regarding the outcome and the determination regarding the outcome, one or more rewards corresponding, respectively, to the one or more predictions; and
training the first model based on the one or more rewards.

22. The system of claim 21, wherein obtaining the input data includes:
extracting context data related to the real-world event from one or more first data records of a data source, wherein each of the one or more first data records includes a timestamp earlier than the first real-world time;
prompting a generative model to generate the task regarding the outcome of the real-world event based on the extracted context data; and
obtaining, from the generative model, the task.

23. The system of claim 22, wherein the information state of the second model includes one or more second data records of the data source, wherein each of the one or more second data records includes a timestamp later than the first real-world time and/or later than the second real-world time.

24. A method comprising performing, by a processor, operations including:
generating, using a first model, response data indicating a prediction regarding an outcome of a second event, wherein the response data are generated based on task data provided as input to the first model, wherein the task data represent a task related to the outcome of the second event, wherein the response data are generated at a third time and the outcome of the second event is unresolved at the third time;
wherein the first model has been trained, using a reinforcement learning algorithm, training data, and one or more rewards, to generate predictions regarding outcomes of events,
wherein the training data include input data and resolution data,
wherein the input data represent a task regarding an outcome of a first event, wherein the outcome of the first event is unresolved as of a first time and resolved as of a second time later than the first time,
wherein synthetic data are provided by the first model based on the input data and an information state observed by the first model, wherein the synthetic data indicate one or more predictions regarding the outcome of the first event, wherein the information state observed by the first model is limited to data available prior to the first time,
wherein the resolution data are provided by a second model based on the input data and an information state observed by the second model, wherein the resolution data indicate a determination regarding the outcome of the first event, and wherein the information state observed by the second model includes data available after the second time,
wherein the one or more rewards are determined based on the one or more predictions and the determination.

25. A method comprising:
providing, to a first generative model, a first prompt to generate one or more tasks based on first data available prior to a first time, wherein the one or more tasks relate to one or more outcomes of one or more events, and wherein the one or more outcomes of the one or more events are unresolved at the first time;
obtaining the one or more tasks generated by the first generative model based on the first data, wherein an information state of the first generative model is limited to data available prior to the first time when the first generative model generates the one or more tasks;
providing, to a second generative model, a second prompt to resolve the one or more tasks based on second data produced after a second time subsequent to the first time;
obtaining resolution data generated by the second generative model based on the second data, wherein the resolution data indicate one or more determinations regarding the one or more outcomes of the one or more events to which the one or more tasks relate, wherein an information state of the second generative model includes data available after the second time when the second generative model generates the resolution data; and
producing, based on the one or more tasks and the resolution data, a data set comprising one or more task records, wherein each task record of the one or more task records includes a respective task of the one or more tasks and a respective determination of the one or more determinations, the respective determination regarding the outcome of the event to which the respective task relates, wherein each task record of the one or more task records further indicates the first time and the second time.

26. The method of claim 25, wherein the first generative model is the second generative model.

27. The method of claim 26, further comprising temporally masking the information state of the first generative model, such that the information state of the first generative model is limited to data available prior to the first time when the first generative model generates the one or more tasks.

28. The method of claim 27, wherein the first data include one or more first timestamped data records, the second data include one or more second timestamped data records, the one or more first timestamped data records and the one or more second timestamped data records are stored in a data store, and temporally masking the information state of the first generative model comprises configuring the data store to prevent the first generative model from accessing timestamped data records having timestamps after the first time.

29. The method of claim 27, wherein the first data include one or more first chronologically ordered data records, the second data include one or more second chronologically ordered data records, the one or more first chronologically ordered data records and the one or more second chronological ordered data records are stored in a data store, and temporally masking the information state of the first generative model comprises configuring the data store to prevent the first generative model from accessing data records subsequent in chronological order to the one or more first chronologically ordered data records.

30. The method of claim 25, wherein producing the data set comprises, for each task of the one or more tasks:
determining whether the respective task satisfies one or more quality criteria;
if the respective task satisfies the one or more quality criteria, adding a record corresponding to the respective task to the data set; and
otherwise, excluding the record corresponding to the respective task from the data set.

31. The method of claim 30, wherein the one or more quality criteria include a difficulty criterion, and wherein the difficulty criterion is satisfied when a difficulty of correctly predicting, at the first time, the outcome of the event to which the respective task relates exceeds a prediction difficulty threshold.

32. The method of claim 30, wherein the one or more quality criteria include a verifiability criterion, and wherein the verifiability criterion is satisfied when a difficulty of verifying, after the second time, the outcome of the event to which the respective task relates is less than a verification difficulty threshold.

33. The method of claim 25, further comprising:
receiving user input identifying a domain for the one or more tasks;
retrieving, from a data source storing a plurality of data records, one or more first data records relating to the identified domain, wherein the data source indicates that the one or more first data records were available prior to the first time; and
retrieving, from the data source, one or more second data records relating to the identified domain, wherein the data source indicates that the one or more second data records were produced after the second time,
wherein the first data include the one or more first data records and the second data include the one or more second data records.

34. The method of claim 25, further comprising training or fine-tuning a third model to predict outcomes of events based on the data set.

35. The method of claim 25, further comprising testing an ability of a third model to predict outcomes of events based on the data set.

36. The method of claim 25, wherein the task is a predictive task.

37. The method of claim 25, wherein the task includes predicting an outcome of an event or generating content related to a predicted outcome of an event.
